(19) United States
(12) Patent Application Publication
(10) Pub. No.: US 2025/0056271 A1
(43) Pub. Date: Feb. 13, 2025

(54) METHOD AND APPARATUS FOR PERFORMING SENSING MEASUREMENT IN WIRELESS LAN SYSTEM

(71) Applicant: LG ELECTRONICS INC., Seoul (KR)

(72) Inventors: Dongguk LIM, Seoul (KR); Jinsoo CHOI, Seoul (KR); Insun JANG, Seoul (KR); Sang Gook KIM, San Diego, CA (US)

(73) Assignee: LG ELECTRONICS INC., Seoul (KR)

(21) Appl. No.: 18/723,693

(22) PCT Filed: Dec. 27, 2022
(86) PCT No.: PCT/KR2022/021425

§ 371 Date: Jun. 24, 2024

Related U.S. Application Data
(60) Provisional application No. 63/293,834, filed on Dec. 27, 2021.

(51) Int. Cl. H04W 24/08; H04W 28/06; H04W 72/0457; H04W 84/12

(52) U.S. Cl. CPC H04W 24/08; H04W 28/06; H04W 72/0457; H04W 84/12

(57) ABSTRACT

Disclosed are a method and an apparatus for performing sensing measurement in a wireless LAN system. A method, according to one embodiment of the present disclosure, may comprise the steps of: receiving a sensing NDPA frame from an AP; and receiving an NDP from the AP. The sensing NDPA frame may include a frame control field and a first field including common information related to sensing measurement for a plurality of STAs, the frame control field may include a subtype subfield, in order to identify the sensing NDPA frame, a value of the subtype subfield may be set to 0110, and a control frame extension value in the subtype subfield may be set to a predetermined value.

### CROSS-REFERENCE TO RELATED APPLICATION(S)

This application is the National Stage filing under 35 U.S.C. 371 of International Application No. PCT/KR2022/021425, filed on Dec. 27, 2022, which claims the benefit of U.S. Provisional Application No. 63/293,834 filed on Dec. 27, 2021, the contents of which are all hereby incorporated by reference herein in their entireties.

### TECHNICAL FIELD

The present disclosure relates to a wireless local area network (WLAN) system, and more specifically, to a method and device for transmitting and receiving a null data packet (NDP) and an NDP announcement (NDPA) frame for sensing measurement.

### BACKGROUND

New technologies for improving transmission rates, increasing bandwidth, improving reliability, reducing errors, and reducing latency have been introduced for a wireless LAN (WLAN). Among WLAN technologies, an Institute of Electrical and Electronics Engineers (IEEE) 802.11 series standard may be referred to as Wi-Fi. For example, technologies recently introduced to WLAN include enhancements for Very High-Throughput (VHT) of the 802.1 lac standard, and enhancements for High Efficiency (HE) of the IEEE 802.11ax standard.

Improvement technologies for providing sensing for devices using wireless LAN signals are being discussed. For example, in IEEE 802.11 task group (TG) bf, standard technology is being developed to perform sensing of objects (e.g., people, objects, etc.) based on channel estimation using wireless LAN signals between devices operating in the frequency band below 7 GHz. Object sensing based on wireless LAN signals has the advantage of utilizing existing frequency bands and has a lower possibility of privacy infringement compared to existing sensing technologies. As the frequency range used in wireless LAN technology increases, precise sensing information can be obtained, and technologies for reducing power consumption to efficiently support precise sensing procedures are also being researched.

### SUMMARY

A technical object of the present disclosure is to provide a method and apparatus for configuring an NDPA frame carrying NDP information when channel estimation using NDP is used to perform sensing using a channel for transmitting and receiving signals between a plurality of sensing STAs in a WLAN system.

In addition, a technical object of the present disclosure is to provide a method and apparatus for transmitting and receiving an NDPA frame and an NDP for sensing measurement.

The technical objects to be achieved by the present disclosure are not limited to the above-described technical objects, and other technical objects which are not described herein will be clearly understood by those skilled in the pertinent art from the following description.

A method performed by a station (STA) in a wireless local area network (WLAN) system according to an aspect of the present disclosure may comprise: receiving a sensing null data packet announcement (NDPA) frame from an access point (AP); and receiving an NDP from the AP. The sensing NDPA frame may include a frame control field and a first field including common information related to sensing measurements for a plurality of STAs, and the frame control field includes a subtype subfield, and the value of the subtype subfield may be set to 0110, and the control frame extension value in the subtype subfield is set to a pre-determined value, to identify the sensing NDPA frame.

A method performed by an access point (AP) in a wireless LAN system according to another aspect of the present disclosure may comprise: transmitting a sensing null data packet announcement (NDPA) frame to a station (STA); and transmitting an NDP to the STA. The sensing NDPA frame may include a frame control field and a first field including common information related to sensing measurements for a plurality of STAs, and the frame control field includes a subtype subfield, and the value of the subtype subfield may be set to 0110, and the control frame extension value in the subtype subfield is set to a pre-determined value, to identify the sensing NDPA frame.

According to an embodiment of the present disclosure, a sensing STA may efficiently perform sensing measurement using (based on) NDP using information transmitted in an NDPA frame.

In addition, according to an embodiment of the present disclosure, the sensing NDPA frame is defined separately, so that the sensing STA may identify the sensing NDPA through the field of the frame.

Effects achievable by the present disclosure are not limited to the above-described effects, and other effects which are not described herein may be clearly understood by those skilled in the pertinent art from the following description.

### BRIEF DESCRIPTION OF THE DRAWINGS

The accompanying drawings, which are included as part of the detailed description to aid understanding of the present disclosure, provide embodiments of the present disclosure and together with the detailed description describe technical features of the present disclosure.

FIG. 1 illustrates a block configuration diagram of a wireless communication device according to an embodiment of the present disclosure.

FIG. 2 is a diagram illustrating an exemplary structure of a WLAN system to which the present disclosure may be applied.

FIG. 3 is a diagram for explaining a link setup process to which the present disclosure may be applied.

FIG. 4 is a diagram for explaining a backoff process to which the present disclosure may be applied.

FIG. 5 is a diagram for explaining a frame transmission operation based on CSMA/CA to which the present disclosure may be applied.

FIG. 6 is a diagram for explaining an example of a frame structure used in a WLAN system to which the present disclosure may be applied.

FIG. 7 is a diagram illustrating examples of PPDUs defined in the IEEE 802.11 standard to which the present disclosure may be applied.

FIGS. 8 to 10 are diagrams for explaining examples of resource units of a WLAN system to which the present disclosure may be applied.

FIG. 11 illustrates an example structure of a HE-SIG-B field.

FIG. 12 is a diagram for explaining a MU-MIMO method in which a plurality of users/STAs are allocated to one RU.

FIG. 13 illustrates an example of a PPDU format to which the present disclosure may be applied.

FIG. 14 is a diagram for explaining a HE Non-TB/TB sounding procedure to which the present disclosure may be applied.

FIG. 15 is a diagram illustrating an NDP announcement frame in a wireless communication system to which the present disclosure may be applied.

FIG. 16 illustrates sensing measurement according to an embodiment of the present disclosure.

FIG. 17 illustrates a sensing NDPA frame format according to an embodiment of the present disclosure.

FIG. 18 is a diagram illustrating an operation of an STA for a method for sensing measurement according to an embodiment of the present disclosure.

FIG. 19 is a diagram illustrating an operation of an AP for a method for sensing measurement according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

Examples of the present disclosure may be applied to various wireless communication systems. For example, examples of the present disclosure may be applied to a wireless LAN system. For example, examples of the present disclosure may be applied to an IEEE 802.11a/g/n/ac/ax standards-based wireless LAN. Furthermore, examples of the present disclosure may be applied to a wireless LAN based on the newly proposed IEEE 802.11be (or EHT) standard. Examples of the present disclosure may be applied to an IEEE 802.11be Release-2 standard-based wireless LAN corresponding to an additional enhancement technology of the IEEE 802.11be Release-1 standard. Additionally, examples of the present disclosure may be applied to a next-generation standards-based wireless LAN after IEEE 802.11be. Further, examples of this disclosure may be applied to a cellular wireless communication system. For example, it may be applied to a cellular wireless communication system based on Long Term Evolution (LTE)-based technology and 5G New Radio (NR)-based technology of the 3rd Generation Partnership Project (3GPP) standard.

Hereinafter, technical features to which examples of the present disclosure may be applied will be described.

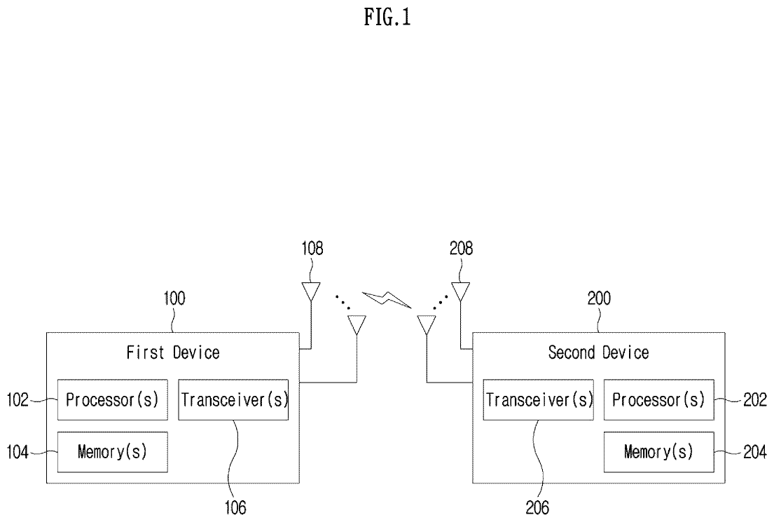

FIG. 1 illustrates a block diagram of a wireless communication device according to an embodiment of the present disclosure.

The first device 100 and the second device 200 illustrated in FIG. 1 may be replaced with various terms such as a terminal, a wireless device, a Wireless Transmit Receive Unit (WTRU), an User Equipment (UE), a Mobile Station (MS), an user terminal (UT), a Mobile Subscriber Station (MSS), a Mobile Subscriber Unit (MSU), a subscriber station (SS), an advanced mobile station (AMS), a wireless terminal (WT), or simply user, etc. In addition, the first device 100 and the second device 200 include an access point (AP), a base station (BS), a fixed station, a Node B, a base transceiver system (BTS), a network, It may be replaced with various terms such as an Artificial Intelligence (AI) system, a road side unit (RSU), a repeater, a router, a relay, and a gateway.

The devices 100 and 200 illustrated in FIG. 1 may be referred to as stations (STAs). For example, the devices 100 and 200 illustrated in FIG. 1 may be referred to by various terms such as a transmitting device, a receiving device, a transmitting STA, and a receiving STA. For example, the STAs 110 and 200 may perform an access point (AP) role or a non-AP role. That is, in the present disclosure, the STAs 110 and 200 may perform functions of an AP and/or a non-AP. When the STAs 110 and 200 perform an AP function, they may be simply referred to as APs, and when the STAs 110 and 200 perform non-AP functions, they may be simply referred to as STAs. In addition, in the present disclosure, an AP may also be indicated as an AP STA.

Referring to FIG. 1, the first device 100 and the second device 200 may transmit and receive radio signals through various wireless LAN technologies (e.g., IEEE 802.11 series). The first device 100 and the second device 200 may include an interface for a medium access control (MAC) layer and a physical layer (PHY) conforming to the IEEE 802.11 standard.

In addition, the first device 100 and the second device 200 may additionally support various communication standards (e.g., 3GPP LTE series, 5G NR series standards, etc.) technologies other than wireless LAN technology. In addition, the device of the present disclosure may be implemented in various devices such as a mobile phone, a vehicle, a personal computer, augmented reality (AR) equipment, and virtual reality (VR) equipment, etc. In addition, the STA of the present specification may support various communication services such as a voice call, a video call, data communication, autonomous-driving, machine-type communication (MTC), machine-to-machine (M2M), device-to-device (D2D), IoT (Internet-of-Things), etc.

A first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including instructions for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless LAN technology (e.g., IEEE 802.11 series). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a device may mean a communication modem/circuit/chip.

A second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including instructions for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless LAN technology (e.g., IEEE 802.11 series). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC). One or more processors 102, 202 may generate one or more PDUs (Protocol Data Unit) and/or one or more SDUs (Service Data Unit) according to description, functions, procedures, proposals, methods and/or operation flow charts disclosed in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, an instruction and/or a set of instructions.

One or more memories 104, 204 may be connected to one or more processors 102, 202 and may store data, a signal, a message, information, a program, a code, an indication and/or an instruction in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

For example, one of the STAs 100 and 200 may perform an intended operation of an AP, and the other of the STAs 100 and 200 may perform an intended operation of a non-AP STA. For example, the transceivers 106 and 206 of FIG. 1 may perform a transmission and reception operation of a signal (e.g., a packet or a physical layer protocol data unit (PPDU) conforming to IEEE 802.11a/b/g/n/ac/ax/be). In addition, in the present disclosure, an operation in which various STAs generate transmission/reception signals or perform data processing or calculation in advance for transmission/reception signals may be performed by the processors 102 and 202 of FIG. 1. For example, an example of an operation of generating a transmission/reception signal or performing data processing or calculation in advance for the transmission/reception signal may include 1) Determining/acquiring/configuring/calculating/decoding/encoding bit information of fields (signal (SIG), short training field (STF), long training field (LTF), Data, etc.) included in the PPDU, 2) Determining/configuring/acquiring time resources or frequency resources (e.g., subcarrier resources) used for fields (SIG, STF, LTF, Data, etc.) included in the PPDU; 3) Determining/configuring/acquiring a specific sequence (e.g., pilot sequence, STF/LTF sequence, extra sequence applied to SIG) used for fields (SIG, STF, LTF, Data, etc.) included in the PPDU action, 4) power control operation and/or power saving operation applied to the STA, 5) Operations related to ACK signal determination/acquisition/configuration/calculation/decoding/encoding, etc. In addition, in the following example, various information (e.g., information related to fields/subfields/control fields/parameters/power, etc.) used by various STAs to determine/acquire/configure/calculate/decode/encode transmission and reception signals may be stored in the memories 104 and 204 of FIG. 1.

Hereinafter, downlink (DL) may mean a link for communication from an AP STA to a non-AP STA, and a DL PPDU/packet/signal may be transmitted and received through the DL. In DL communication, a transmitter may be part of an AP STA, and a receiver may be part of a non-AP STA. Uplink (UL) may mean a link for communication from non-AP STAs to AP STAs, and a UL PPDU/packet/signal may be transmitted and received through the UL. In UL communication, a transmitter may be part of a non-AP STA, and a receiver may be part of an AP STA.

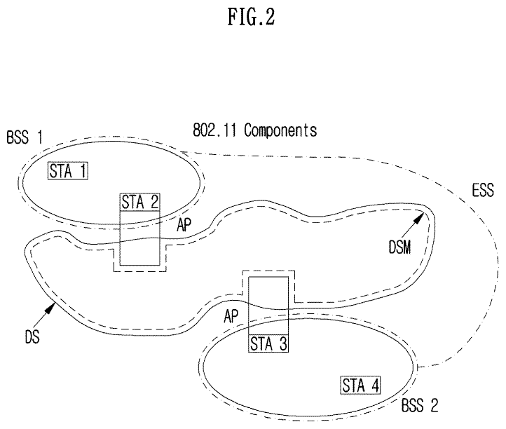

FIG. 2 is a diagram illustrating an exemplary structure of a wireless LAN system to which the present disclosure may be applied.

The structure of the wireless LAN system may consist of be composed of a plurality of components. A wireless LAN supporting STA mobility transparent to an upper layer may be provided by interaction of a plurality of components. A Basic Service Set (BSS) corresponds to a basic construction block of a wireless LAN. FIG. 2 exemplarily shows that two BSSs (BSS1 and BSS2) exist and two STAs are included as members of each BSS (STA1 and STA2 are included in BSS1, and STA3 and STA4 are included in BSS2). An ellipse representing a BSS in FIG. 2 may also be understood as representing a coverage area in which STAs included in the corresponding BSS maintain communication. This area may be referred to as a Basic Service Area (BSA). When an STA moves out of the BSA, it may not directly communicate with other STAs within the BSA.

If the DS shown in FIG. 2 is not considered, the most basic type of BSS in a wireless LAN is an independent BSS (IBSS). For example, IBSS may have a minimal form contaning only two STAs. For example, assuming that other components are omitted, BSS1 contaning only STA1 and STA2 or BSS2 contaning only STA3 and STA4 may respectively correspond to representative examples of IBSS. This configuration is possible when STAs may communicate directly without an AP. In addition, in this type of wireless LAN, it is not configured in advance, but may be configured when a LAN is required, and this may be referred to as an ad-hoc network. Since the IBSS does not include an AP, there is no centralized management entity. That is, in IBSS, STAs are managed in a distributed manner. In IBSS, all STAs may be made up of mobile STAs, and access to the distributed system (DS) is not allowed, forming a self-contained network.

Membership of an STA in the BSS may be dynamically changed by turning on or off the STA, entering or exiting the BSS area, and the like. To become a member of the BSS, the STA may join the BSS using a synchronization process. In order to access all services of the BSS infrastructure, the STA shall be associated with the BSS. This association may be dynamically established and may include the use of a Distribution System Service (DSS).

A direct STA-to-STA distance in a wireless LAN may be limited by PHY performance. In some cases, this distance limit may be sufficient, but in some cases, communication between STAs at a longer distance may be required. A distributed system (DS) may be configured to support extended coverage.

DS means a structure in which BSSs are interconnected. Specifically, as shown in FIG. 2, a BSS may exist as an extended form of a network composed of a plurality of BSSs. DS is a logical concept and may be specified by the characteristics of Distributed System Media (DSM). In this regard, a wireless medium (WM) and a DSM may be logically separated. Each logical medium is used for a different purpose and is used by different components. These medium are not limited to being the same, nor are they limited to being different. In this way, the flexibility of the wireless LAN structure (DS structure or other network structure) may be explained in that a plurality of media are logically different. That is, the wireless LAN structure may be implemented in various ways, and the corresponding wireless LAN structure may be independently specified by the physical characteristics of each embodiment.

A DS may support a mobile device by providing seamless integration of a plurality of BSSs and providing logical services necessary to address an address to a destination. In addition, the DS may further include a component called a portal that serves as a bridge for connection between the wireless LAN and other networks (e.g., IEEE 802.X).

The AP enables access to the DS through the WM for the associated non-AP STAs, and means an entity that also has the functionality of an STA. Data movement between the BSS and the DS may be performed through the AP. For example, STA2 and STA3 shown in FIG. 2 have the functionality of STAs, and provide a function allowing the associated non-AP STAs (STA1 and STA4) to access the DS. In addition, since all APs basically correspond to STAs, all APs are addressable entities. The address used by the AP for communication on the WM and the address used by the AP for communication on the DSM are not necessarily the same. A BSS composed of an AP and one or more STAs may be referred to as an infrastructure BSS.

Data transmitted from one of the STA(s) associated with an AP to a STA address of the corresponding AP may be always received on an uncontrolled port and may be processed by an IEEE 802.1X port access entity. In addition, when a controlled port is authenticated, transmission data (or frames) may be delivered to the DS.

In addition to the structure of the DS described above, an extended service set (ESS) may be configured to provide wide coverage.

An ESS means a network in which a network having an arbitrary size and complexity is composed of DSs and BSSs. The ESS may correspond to a set of BSSs connected to one DS. However, the ESS does not include the DS. An ESS network is characterized by being seen as an IBSS in the Logical Link Control (LLC) layer. STAs included in the ESS may communicate with each other, and mobile STAs may move from one BSS to another BSS (within the same ESS) transparently to the LLC. APs included in one ESS may have the same service set identification (SSID). The SSID is distinguished from the BSSID, which is an identifier of the BSS.

The wireless LAN system does not assume anything about the relative physical locations of BSSs, and all of the following forms are possible. BSSs may partially overlap, which is a form commonly used to provide continuous coverage. In addition, BSSs may not be physically connected, and logically there is no limit on the distance between BSSs. In addition, the BSSs may be physically located in the same location, which may be used to provide redundancy. In addition, one (or more than one) IBSS or ESS networks may physically exist in the same space as one (or more than one) ESS network. When an ad-hoc network operates in a location where an ESS network exists, when physically overlapping wireless networks are configured by different organizations, or when two or more different access and security policies are required in the same location, this may correspond to the form of an ESS network in the like.

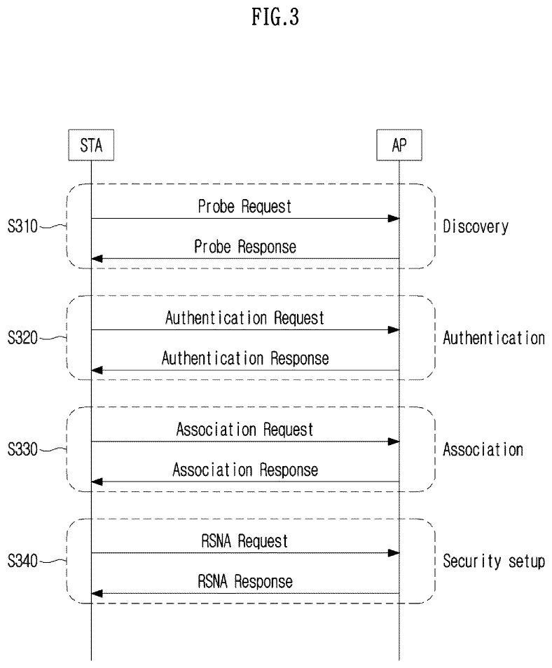

FIG. 3 is a diagram for explaining a link setup process to which the present disclosure may be applied.

In order for an STA to set up a link with respect to a network and transmit/receive data, it first discovers a network, performs authentication, establishes an association, and need to perform the authentication process for security. The link setup process may also be referred to as a session initiation process or a session setup process. In addition, the processes of discovery, authentication, association, and security setting of the link setup process may be collectively referred to as an association process.

In step S310, the STA may perform a network discovery operation. The network discovery operation may include a scanning operation of the STA. That is, in order for the STA to access the network, it needs to find a network in which it can participate. The STA shall identify a compatible network before participating in a wireless network, and the process of identifying a network existing in a specific area is called scanning.

Scanning schemes include active scanning and passive scanning. FIG. 3 exemplarily illustrates a network discovery operation including an active scanning process. In active scanning, an STA performing scanning transmits a probe request frame to discover which APs exist around it while moving channels and waits for a response thereto. A responder transmits a probe response frame as a response to the probe request frame to the STA that has transmitted the probe request frame. Here, the responder may be an STA that last transmitted a beacon frame in the BSS of the channel being scanned. In the BSS, since the AP transmits the beacon frame, the AP becomes a responder, and in the IBSS, the STAs in the IBSS rotate to transmit the beacon frame, so the responder is not constant. For example, a STA that transmits a probe request frame on channel 1 and receives a probe response frame on channel 1, may store BSS-related information included in the received probe response frame and may move to the next channel (e.g., channel 2) and perform scanning (i.e., transmission/reception of a probe request/response on channel 2) in the same manner.

Although not shown in FIG. 3, the scanning operation may be performed in a passive scanning manner. In passive scanning, a STA performing scanning waits for a beacon frame while moving channels. The beacon frame is one of the management frames defined in IEEE 802.11, and is periodically transmitted to notify the existence of a wireless network and to allow the STA performing scanning to find a wireless network and participate in the wireless network. In the BSS, the AP serves to transmit beacon frames periodically, and in the IBSS, STAs within the IBSS rotate to transmit beacon frames. When the STA performing scanning receives a beacon frame, the STA stores information for the BSS included in the beacon frame and records beacon frame information in each channel while moving to another channel. The STA receiving the beacon frame may store BSS-related information included in the received beacon frame, move to the next channel, and perform scanning in the next channel in the same way. Comparing active scanning and passive scanning, active scanning has an advantage of having less delay and less power consumption than passive scanning.

After the STA discovers the network, an authentication process may be performed in step S320. This authentication process may be referred to as a first authentication process in order to be clearly distinguished from the security setup operation of step S340 to be described later.

The authentication process includes a process in which the STA transmits an authentication request frame to the AP, and in response to this, the AP transmits an authentication response frame to the STA. An authentication frame used for authentication request/response corresponds to a management frame.

The authentication frame includes an authentication algorithm number, an authentication transaction sequence number, a status code, a challenge text, a robust security network (RSN), and a Finite Cyclic Group, etc. This corresponds to some examples of information that may be included in the authentication request/response frame, and may be replaced with other information or additional information may be further included.

The STA may transmit an authentication request frame to the AP. The AP may determine whether to allow authentication of the corresponding STA based on information included in the received authentication request frame. The AP may provide the result of the authentication process to the STA through an authentication response frame.

After the STA is successfully authenticated, an association process may be performed in step S330. The association process includes a process in which the STA transmits an association request frame to the AP, and in response, the AP transmits an association response frame to the STA.

For example, the association request frame may include information related to various capabilities, a beacon listen interval, a service set identifier (SSID), supported rates, supported channels, RSN, mobility domain, supported operating classes, Traffic Indication Map Broadcast request (TIM broadcast request), interworking service capability, etc. For example, the association response frame may include information related to various capabilities, status code, association ID (AID), supported rates, enhanced distributed channel access (EDCA) parameter set, received channel power indicator (RCPI), received signal to noise indicator (RSNI), mobility domain, timeout interval (e.g., association comeback time), overlapping BSS scan parameters, TIM broadcast response, Quality of Service (QoS) map, etc. This corresponds to some examples of information that may be included in the association request/response frame, and may be replaced with other information or additional information may be further included.

After the STA is successfully associated with the network, a security setup process may be performed in step S340. The security setup process of step S340 may be referred to as an authentication process through Robust Security Network Association (RSNA) request/response, and the authentication process of step S320 is referred to as a first authentication process, and the security setup process of step S340 may also simply be referred to as an authentication process.

The security setup process of step S340 may include, for example, a process of setting up a private key through 4-way handshaking through an Extensible Authentication Protocol over LAN (EAPOL) frame. In addition, the security setup process may be performed according to a security scheme not defined in the IEEE 802.11 standard.

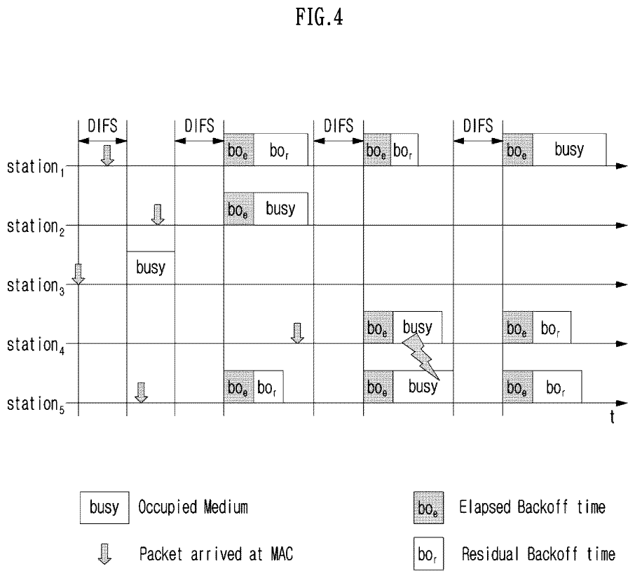

FIG. 4 is a diagram for explaining a backoff process to which the present disclosure may be applied.

In the wireless LAN system, a basic access mechanism of medium access control (MAC) is a carrier sense multiple access with collision avoidance (CSMA/CA) mechanism. The CSMA/CA mechanism is also called Distributed Coordination Function (DCF) of IEEE 802.11 MAC, and basically adopts a “listen before talk” access mechanism. According to this type of access mechanism, the AP and/or STA may perform Clear Channel Assessment (CCA) sensing a radio channel or medium during a predetermined time interval (e.g., DCF Inter-Frame Space (DIFS)), prior to starting transmission. As a result of the sensing, if it is determined that the medium is in an idle state, frame transmission is started through the corresponding medium. On the other hand, if it is detected that the medium is occupied or busy, the corresponding AP and/or STA does not start its own transmission and may set a delay period for medium access (e.g., a random backoff period) and attempt frame transmission after waiting. By applying the random backoff period, since it is expected that several STAs attempt frame transmission after waiting for different periods of time, collision may be minimized.

In addition, the IEEE 802.11 MAC protocol provides a Hybrid Coordination Function (HCF). HCF is based on the DCF and Point Coordination Function (PCF). PCF is a polling-based synchronous access method and refers to a method in which all receiving APs and/or STAs periodically poll to receive data frames. In addition, HCF has Enhanced Distributed Channel Access (EDCA) and HCF Controlled Channel Access (HCCA). EDCA is a contention-based access method for a provider to provide data frames to multiple users, and HCCA uses a non-contention-based channel access method using a polling mechanism. In addition, the HCF includes a medium access mechanism for improving QoS (Quality of Service) of the wireless LAN, and may transmit QoS data in both a Contention Period (CP) and a Contention Free Period (CFP).

Referring to FIG. 4, an operation based on a random backoff period will be described. When the occupied/busy medium changes to an idle state, several STAs may attempt to transmit data (or frames). As a method for minimizing collisions, each of STAs may respectively select a random backoff count and attempt transmission after waiting for a corresponding slot time. The random backoff count has a pseudo-random integer value and may be determined as one of values ranging from 0 to CW. Here, CW is a contention window parameter value. The CW parameter is given CWmin as an initial value, but may take a value twice as large in case of transmission failure (e.g., when an ACK for the transmitted frame is not received). When the CW parameter value reaches CWmax, data transmission may be attempted while maintaining the CWmax value until data transmission is successful, and when data transmission is successful, the CWmin value is reset. The values of CW, CWmin and CWmax are preferably set to 2n−1 (n=0, 1, 2, . . . ).

When the random backoff process starts, the STA continuously monitors the medium while counting down the backoff slots according to the determined backoff count value.

When the medium is monitored for occupancy, it stops counting down and waits, and resumes the rest of the countdown when the medium becomes idle.

In the example of FIG. 4, when a packet to be transmitted arrives at the MAC of STA3, STA3 may transmit the frame immediately after confirming that the medium is idle as much as DIFS. The remaining STAs monitor and wait for the medium to be occupied/busy. In the meantime, data to be transmitted may also occur in each of STAT, STA2, and STA5, and each STA waits as long as DIFS when the medium is monitored as idle, and then may perform a countdown of the backoff slot according to the random backoff count value selected by each STA. Assume that STA2 selects the smallest backoff count value and STAT selects the largest backoff count value. That is, the case where the remaining back-off time of STA5 is shorter than the remaining back-off time of STAT at the time when STA2 completes the back-off count and starts frame transmission is exemplified. STAT and STA5 temporarily stop counting down and wait while STA2 occupies the medium. When the occupation of STA2 ends and the medium becomes idle again, STAT and STA5 wait for DIFS and resume the stopped backoff count. That is, frame transmission may be started after counting down the remaining backoff slots for the remaining backoff time. Since the remaining backoff time of STA5 is shorter than that of STAT, STA5 starts frame transmission. While STA2 occupies the medium, data to be transmitted may also occur in STA4. From the standpoint of STA4, when the medium becomes idle, STA4 may wait for DIFS, and then may perform a countdown according to the random backoff count value selected by the STA4 and start transmitting frames. The example of FIG. 4 shows a case where the remaining backoff time of STA5 coincides with the random backoff count value of STA4 by chance. In this case, a collision may occur between STA4 and STA5. When a collision occurs, both STA4 and STA5 do not receive an ACK, so data transmission fails. In this case, STA4 and STA5 may double the CW value, select a random backoff count value, and perform a countdown. STA1 waits while the medium is occupied due to transmission of STA4 and STA5, waits for DIFS when the medium becomes idle, and then starts frame transmission after the remaining backoff time has elapsed.

As in the example of FIG. 4, the data frame is a frame used for transmission of data forwarded to a higher layer, and may be transmitted after a backoff performed after DIFS elapses from when the medium becomes idle. Additionally, the management frame is a frame used for exchange of management information that is not forwarded to a higher layer, and is transmitted after a backoff performed after an IFS such as DIFS or Point Coordination Function IFS (PIFS). As a subtype frames of management frame, there are a Beacon, an association request/response, a re-association request/response, a probe request/response, an authentication request/response, etc. A control frame is a frame used to control access to a medium. As a subtype frames of control frame, there are Request-To-Send (RTS), Clear-To-Send (CTS), Acknowledgement (ACK), Power Save-Poll (PS-Poll), block ACK (BlockAck), block ACK request (BlockACKReq), null data packet announcement (NDP announcement), and trigger, etc. If the control frame is not a response frame of the previous frame, it is transmitted after backoff performed after DIFS elapses, and if it is a response frame of the previous frame, it is transmitted without performing backoff after short IFS (SIFS) elapses. The type and subtype of the frame may be identified by a type field and a subtype field in a frame control (FC) field.

A Quality of Service (QoS) STA may perform the backoff that is performed after an arbitration IFS (AIFS) for an access category (AC) to which the frame belongs, that is, AIFS[i] (where i is a value determined by AC), and then may transmit the frame. Here, the frame in which AIFS[i] can be used may be a data frame, a management frame, or a control frame other than a response frame.

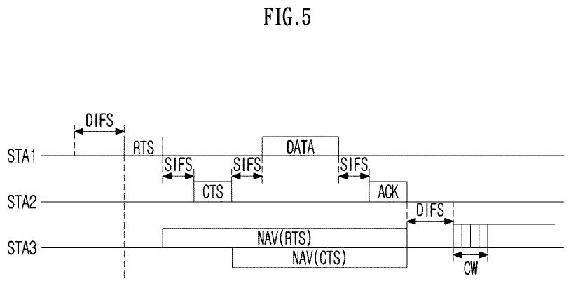

FIG. 5 is a diagram for explaining a frame transmission operation based on CSMA/CA to which the present disclosure may be applied.

As described above, the CSMA/CA mechanism includes virtual carrier sensing in addition to physical carrier sensing in which a STA directly senses a medium. Virtual carrier sensing is intended to compensate for problems that may occur in medium access, such as a hidden node problem. For virtual carrier sensing, the MAC of the STA may use a Network Allocation Vector (NAV). The NAV is a value indicating, to other STAs, the remaining time until the medium is available for use by an STA currently using or having the right to use the medium. Therefore, the value set as NAV corresponds to a period in which the medium is scheduled to be used by the STA transmitting the frame, and the STA receiving the NAV value is prohibited from accessing the medium during the corresponding period. For example, the NAV may be configured based on the value of the “duration” field of the MAC header of the frame.

In the example of FIG. 5, it is assumed that a STA1 intends to transmit data to a STA2, and a STA3 is in a position capable of overhearing some or all of frames transmitted and received between the STA1 and the STA2.

In order to reduce the possibility of collision of transmissions of multiple STAs in CSMA/CA based frame transmission operation, a mechanism using RTS/CTS frames may be applied. In the example of FIG. 5, while transmission of the STA1 is being performed, as a result of carrier sensing of the STA3, it may be determined that the medium is in an idle state. That is, the STA1 may correspond to a hidden node to the STA3. Alternatively, in the example of FIG. 5, it may be determined that the carrier sensing result medium of the STA3 is in an idle state while transmission of the STA2 is being performed. That is, the STA2 may correspond to a hidden node to the STA3. Through the exchange of RTS/CTS frames before performing data transmission and reception between the STA1 and the STA2, a STA outside the transmission range of one of the STA1 or the STA2, or a STA outside the carrier sensing range for transmission from the STA1 or the STA3 may not attempt to occupy the channel during data transmission and reception between the STA1 and the STA2.

Specifically, the STA1 may determine whether a channel is being used through carrier sensing. In terms of physical carrier sensing, the STA1 may determine a channel occupation idle state based on an energy level or signal correlation detected in a channel. In addition, in terms of virtual carrier sensing, the STA1 may determine a channel occupancy state using a network allocation vector (NAV) timer.

The STA1 may transmit an RTS frame to the STA2 after performing a backoff when the channel is in an idle state during DIFS. When the STA2 receives the RTS frame, the STA2 may transmit a CTS frame as a response to the RTS frame to the STA1 after SIFS.

If the STA3 cannot overhear the CTS frame from the STA2 but can overhear the RTS frame from the STA1, the STA3 may set a NAV timer for a frame transmission period (e.g., SIFS+CTS frame+SIFS+data frame+SIFS+ACK frame) that is continuously transmitted thereafter, using the duration information included in the RTS frame. Alternatively, if the STA3 can overhear a CTS frame from the STA2 although the STA3 cannot overhear an RTS frame from the STA1, the STA3 may set a NAV timer for a frame transmission period (e.g., SIFS+data frame+SIFS+ACK frame) that is continuously transmitted thereafter, using the duration information included in the CTS frame. That is, if the STA3 can overhear one or more of the RTS or CTS frames from one or more of the STA1 or the STA2, the STA3 may set the NAV accordingly. When the STA3 receives a new frame before the NAV timer expires, the STA3 may update the NAV timer using duration information included in the new frame. The STA3 does not attempt channel access until the NAV timer expires.

When the STA1 receives the CTS frame from the the STA2, the STA1 may transmit the data frame to the STA2 after SIFS from the time point when the reception of the CTS frame is completed. When the STA2 successfully receives the data frame, the STA2 may transmit an ACK frame as a response to the data frame to the STA1 after SIFS. The STA3 may determine whether the channel is being used through carrier sensing when the NAV timer expires. When the STA3 determines that the channel is not used by other terminals during DIFS after expiration of the NAV timer, the STA3 may attempt channel access after a contention window (CW) according to a random backoff has passed.

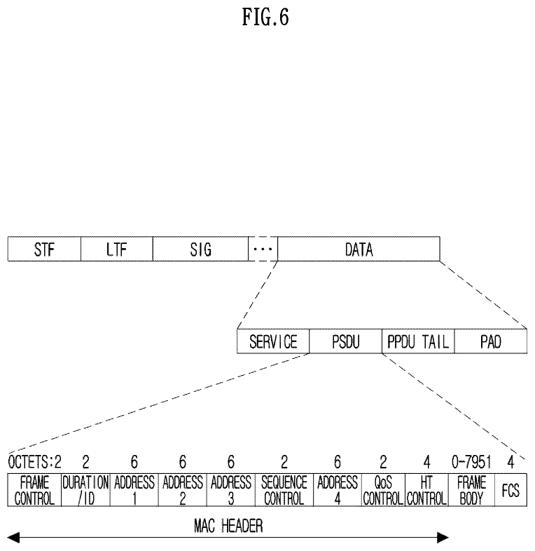

FIG. 6 is a diagram for explaining an example of a frame structure used in a WLAN system to which the present disclosure may be applied.

By means of an instruction or primitive (meaning a set of instructions or parameters) from the MAC layer, the PHY layer may prepare a MAC PDU (MPDU) to be transmitted. For example, when a command requesting transmission start of the PHY layer is received from the MAC layer, the PHY layer switches to the transmission mode and configures information (e.g., data) provided from the MAC layer in the form of a frame and transmits it. In addition, when the PHY layer detects a valid preamble of the received frame, the PHY layer monitors the header of the preamble and sends a command notifying the start of reception of the PHY layer to the MAC layer.

In this way, information transmission/reception in a wireless LAN system is performed in the form of a frame, and for this purpose, a PHY layer protocol data unit (PPDU) frame format is defined.

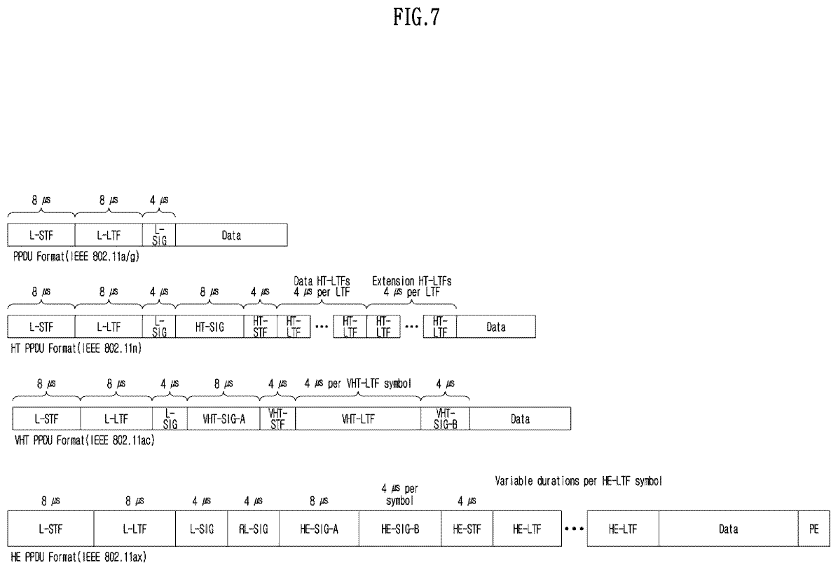

A basic PPDU frame may include a Short Training Field (STF), a Long Training Field (LTF), a SIGNAL (SIG) field, and a Data field. The most basic (e.g., non-High Throughput (HT)) PPDU frame format may consist of only L-STF (Legacy-STF), L-LTF (Legacy-LTF), SIG field, and data field. In addition, depending on the type of PPDU frame format (e.g., HT-mixed format PPDU, HT-greenfield format PPDU, VHT (Very High Throughput) PPDU, etc.), an additional (or different type) STF, LTF, and SIG fields may be included between the SIG field and the data field (this will be described later with reference to FIG. 7).

The STF is a signal for signal detection, automatic gain control (AGC), diversity selection, precise time synchronization, and the like, and the LTF is a signal for channel estimation and frequency error estimation. The STF and LTF may be referred to as signals for synchronization and channel estimation of the OFDM physical layer.

The SIG field may include a RATE field and a LENGTH field. The RATE field may include information on modulation and coding rates of data. The LENGTH field may include information on the length of data. Additionally, the SIG field may include a parity bit, a SIG TAIL bit, and the like.

The data field may include a SERVICE field, a physical layer service data unit (PSDU), and a PPDU TAIL bit, and may also include padding bits if necessary. Some bits of the SERVICE field may be used for synchronization of the descrambler at the receiving end. The PSDU corresponds to the MAC PDU defined in the MAC layer, and may include data generated/used in the upper layer. The PPDU TAIL bit may be used to return the encoder to a 0 state. Padding bits may be used to adjust the length of a data field in a predetermined unit.

A MAC PDU is defined according to various MAC frame formats, and a basic MAC frame consists of a MAC header, a frame body, and a Frame Check Sequence (FCS). The MAC frame may consist of MAC PDUs and be transmitted/received through the PSDU of the data part of the PPDU frame format.

The MAC header includes a Frame Control field, a Duration/ID field, an Address field, and the like. The frame control field may include control information required for frame transmission/reception. The duration/ID field may be set to a time for transmitting a corresponding frame or the like. For details of the Sequence Control, QoS Control, and HT Control subfields of the MAC header, refer to the IEEE 802.11 standard document.

A null-data packet (NDP) frame format means a frame format that does not include a data packet. That is, the NDP frame refers to a frame format that includes a physical layer convergence procedure (PLCP) header part (i.e., STF, LTF, and SIG fields) in a general PPDU frame format and does not include the remaining parts (i.e., data field). A NDP frame may also be referred to as a short frame format.

FIG. 7 is a diagram illustrating examples of PPDUs defined in the IEEE 802.11 standard to which the present disclosure may be applied.

In standards such as IEEE 802.11a/g/n/ac/ax, various types of PPDUs have been used. The basic PPDU format (IEEE 802.11a/g) includes L-LTF, L-STF, L-SIG and Data fields. The basic PPDU format may also be referred to as a non-HT PPDU format.

The HT PPDU format (IEEE 802.11n) additionally includes HT-SIG, HT-STF, and HT-LFT(s) fields to the basic PPDU format. The HT PPDU format shown in FIG. 7 may be referred to as an HT-mixed format. In addition, an HT-greenfield format PPDU may be defined, and this corresponds to a format consisting of HT-GF-STF, HT-LTF1, HT-SIG, one or more HT-LTF, and Data field, not including L-STF, L-LTF, and L-SIG (not shown).

An example of the VHT PPDU format (IEEE 802.1 lac) additionally includes VHT SIG-A, VHT-STF, VHT-LTF, and VHT-SIG-B fields to the basic PPDU format.

An example of the HE PPDU format (IEEE 802.1 lax) additionally includes Repeated L-SIG (RL-SIG), HE-SIG-A, HE-SIG-B, HE-STF, HE-LTF(s), Packet Extension (PE) field to the basic PPDU format. Some fields may be excluded or their length may vary according to detailed examples of the HE PPDU format. For example, the HE-SIG-B field is included in the HE PPDU format for multi-user (MU), and the HE-SIG-B is not included in the HE PPDU format for single user (SU). In addition, the HE trigger-based (TB) PPDU format does not include the HE-SIG-B, and the length of the HE-STF field may vary to 8 us. The Extended Range (HE ER) SU PPDU format does not include the HE-SIG-B field, and the length of the HE-SIG-A field may vary to 16 us.

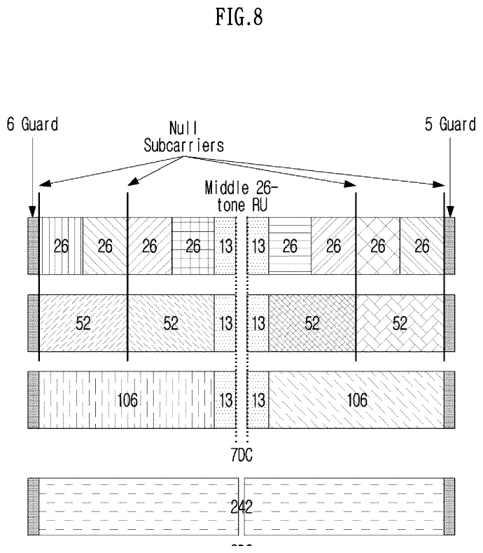

FIGS. 8 to 10 are diagrams for explaining examples of resource units of a WLAN system to which the present disclosure may be applied.

Referring to FIGS. 8 to 10, a resource unit (RU) defined in a wireless LAN system will be described. the RU may include a plurality of subcarriers (or tones). The RU may be used when transmitting signals to multiple STAs based on the OFDMA scheme. In addition, the RU may be defined even when a signal is transmitted to one STA. The RU may be used for STF, LTF, data field of the PPDU, etc.

As shown in FIGS. 8 to 10, RUs corresponding to different numbers of tones (i.e., subcarriers) are used to construct some fields of 20 MHz, 40 MHz, or 80 MHz X-PPDUs (X is HE, EHT, etc.). For example, resources may be allocated in RU units shown for the X-STF, X-LTF, and Data field.

FIG. 8 is a diagram illustrating an exemplary allocation of resource units (RUs) used on a 20 MHz band.

As shown at the top of FIG. 8, 26-units (i.e., units corresponding to 26 tones) may be allocated. 6 tones may be used as a guard band in the leftmost band of the 20 MHz band, and 5 tones may be used as a guard band in the rightmost band of the 20 MHz band. In addition, 7 DC tones are inserted in the center band, that is, the DC band, and 26-units corresponding to each of the 13 tones may exist on the left and right sides of the DC band. In addition, 26-unit, 52-unit, and 106-unit may be allocated to other bands. Each unit may be allocated for STAs or users.

The RU allocation of FIG. 8 is utilized not only in a situation for multiple users (MU) but also in a situation for a single user (SU), and in this case, it is possible to use one 242-unit as shown at the bottom of FIG. 8. In this case, three DC tones may be inserted.

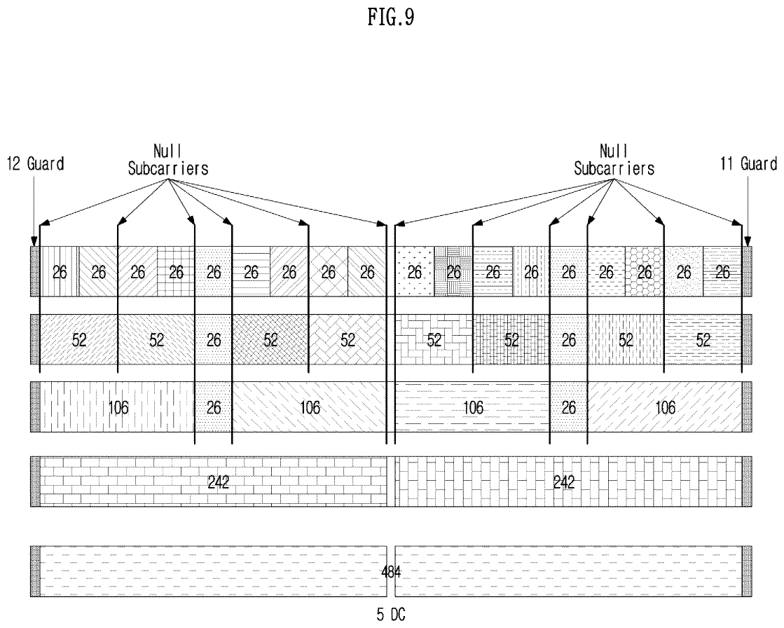

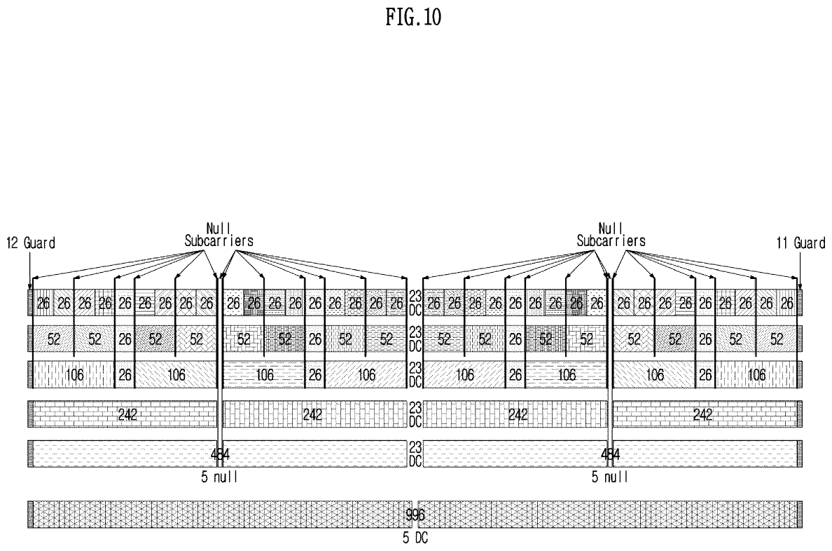

In the example of FIG. 8, RUs of various sizes, that is, 26-RU, 52-RU, 106-RU, 242-RU, etc. are exemplified, but the specific size of these RUs may be reduced or expanded. Therefore, in the present disclosure, the specific size of each RU (i.e., the number of corresponding tones) is exemplary and not restrictive. In addition, within a predetermined bandwidth (e.g., 20, 40, 80, 160, 320 MHz, . . . ) in the present disclosure, the number of RUs may vary according to the size of the RU. In the examples of FIG. 9 and/or FIG. 10 to be described below, the fact that the size and/or number of RUs may be varied is the same as the example of FIG. 8.

FIG. 9 is a diagram illustrating an exemplary allocation of resource units (RUs) used on a 40 MHz band.

Just as RUs of various sizes are used in the example of FIG. 8, 26-RU, 52-RU, 106-RU, 242-RU, 484-RU, and the like may be used in the example of FIG. 9 as well. In addition, 5 DC tones may be inserted at the center frequency, 12 tones may be used as a guard band in the leftmost band of the 40 MHz band, and 11 tones may be used as a guard band in the rightmost band of the 40 MHz band.

In addition, as shown, when used for a single user, a 484-RU may be used.

FIG. 10 is a diagram illustrating an exemplary allocation of resource units (RUs) used on an 80 MHz band.

Just as RUs of various sizes are used in the example of FIG. 8 and FIG. 9, 26-RU, 52-RU, 106-RU, 242-RU, 484-RU, 996-RU and the like may be used in the example of FIG. 10 as well. In addition, in the case of an 80 MHz PPDU, RU allocation of HE PPDUs and EHT PPDUs may be different, and the example of FIG. 10 shows an example of RU allocation for 80 MHz EHT PPDUs. The scheme that 12 tones are used as a guard band in the leftmost band of the 80 MHz band and 11 tones are used as a guard band in the rightmost band of the 80 MHz band in the example of FIG. 10 is the same in HE PPDU and EHT PPDU. Unlike HE PPDU, where 7 DC tones are inserted in the DC band and there is one 26-RU corresponding to each of the 13 tones on the left and right sides of the DC band, in the EHT PPDU, 23 DC tones are inserted into the DC band, and one 26-RU exists on the left and right sides of the DC band. Unlike the HE PPDU, where one null subcarrier exists between 242-RUs rather than the center band, there are five null subcarriers in the EHT PPDU. In the HE PPDU, one 484-RU does not include null subcarriers, but in the EHT PPDU, one 484-RU includes 5 null subcarriers.

In addition, as shown, when used for a single user, 996-RU may be used, and in this case, 5 DC tones are inserted in common with HE PPDU and EHT PPDU.

EHT PPDUs over 160 MHz may be configured with a plurality of 80 MHz subblocks in FIG. 10. The RU allocation for each 80 MHz subblock may be the same as that of the 80 MHz EHT PPDU of FIG. 10. If the 80 MHz subblock of the 160 MHz or 320 MHz EHT PPDU is not punctured and the entire 80 MHz subblock is used as part of RU or multiple RU (MRU), the 80 MHz subblock may use 996-RU of FIG. 10.

Here, the MRU corresponds to a group of subcarriers (or tones) composed of a plurality of RUs, and the plurality of RUs constituting the MRU may be RUs having the same size or RUs having different sizes. For example, a single MRU may be defined as 52+26-tone, 106+26-tone, 484+242-tone, 996+484-tone, 996+484+242-tone, 2×996+484-tone, 3×996-tone, or 3×996+484-tone. Here, the plurality of RUs constituting one MRU may correspond to small size (e.g., 26, 52, or 106) RUs or large size (e.g., 242, 484, or 996) RUs.

That is, one MRU including a small size RU and a large size RU may not be configured/defined. In addition, a plurality of RUs constituting one MRU may or may not be consecutive in the frequency domain.

When an 80 MHz subblock includes RUs smaller than 996 tones, or parts of the 80 MHz subblock are punctured, the 80 MHz subblock may use RU allocation other than the 996-tone RU.

The RU of the present disclosure may be used for uplink (UL) and/or downlink (DL) communication. For example, when trigger-based UL-MU communication is performed, the STA transmitting the trigger (e.g., AP) may allocate a first RU (e.g., 26/52/106/242-RU, etc.) to a first STA and allocate a second RU (e.g., 26/52/106/242-RU, etc.) to a second STA, through trigger information (e.g., trigger frame or triggered response scheduling (TRS)). Thereafter, the first STA may transmit a first trigger-based (TB) PPDU based on the first RU, and the second STA may transmit a second TB PPDU based on the second RU. The first/second TB PPDUs may be transmitted to the AP in the same time period.

For example, when a DL MU PPDU is configured, the STA transmitting the DL MU PPDU (e.g., AP) may allocate a first RU (e.g., 26/52/106/242-RU, etc.) to a first STA and allocate a second RU (e.g., 26/52/106/242-RU, etc.) to a second STA. That is, the transmitting STA (e.g., AP) may transmit HE-STF, HE-LTF, and Data field for the first STA through the first RU and transmit HE-STF, HE-LTF, and Data field for the second STA through the second RU, in one MU PPDU,

Information on the allocation of RUs may be signaled through HE-SIG-B in the HE PPDU format.

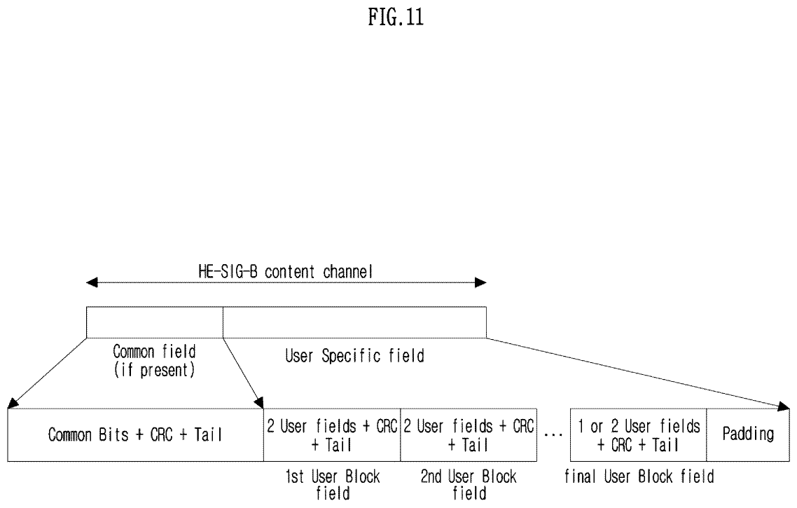

FIG. 11 illustrates an example structure of a HE-SIG-B field.

As shown, the HE-SIG-B field may include a common field and a user-specific field.

If HE-SIG-B compression is applied (e.g., full-bandwidth MU-MIMO transmission), the common field may not be included in HE-SIG-B, and the HE-SIG-B content channel may include only a user-specific field. If HE-SIG-B compression is not applied, the common field may be included in HE-SIG-B.

The common field may include information on RU allocation (e.g., RU assignment, RUs allocated for MU-MIMO, the number of MU-MIMO users (STAs), etc.)

The common field may include N*8 RU allocation subfields. Here, N is the number of subfields, N=1 in the case of 20 or 40 MHz MU PPDU, N=2 in the case of 80 MHz MU PPDU, N=4 in the case of 160 MHz or 80+80 MHz MU PPDU, etc. One 8-bit RU allocation subfield may indicate the size (26, 52, 106, etc.) and frequency location (or RU index) of RUs included in the 20 MHz band.

For example, if a value of the 8-bit RU allocation subfield is 00000000, it may indicate that nine 26-RUs are sequentially allocated in order from the leftmost to the rightmost in the example of FIG. 8, if the value is 00000001, it may indicate that seven 26-RUs and one 52-RU are sequentially allocated in order from leftmost to rightest, and if the value is 00000010, it may indicate that five 26-RUs, one 52-RU, and two 26-RUs are sequentially allocated from the leftmost side to the rightmost side.

As an additional example, if the value of the 8-bit RU allocation subfield is 01000y2y1y0, it may indicate that one 106-RU and five 26-RUs are sequentially allocated from the leftmost to the rightmost in the example of FIG. 8. In this case, multiple users/STAs may be allocated to the 106-RU in the MU-MIMO scheme. Specifically, up to 8 users/STAs may be allocated to the 106-RU, and the number of users/STAs allocated to the 106-RU is determined based on 3-bit information (i.e., y2y1y0). For example, when the 3-bit information (y2y1y0) corresponds to a decimal value N, the number of users/STAs allocated to the 106-RU may be N+1.

Basically, one user/STA may be allocated to each of a plurality of RUs, and different users/STAs may be allocated to different RUs. For RUs larger than a predetermined size (e.g., 106, 242, 484, 996-tones, . . . ), a plurality of users/STAs may be allocated to one RU, and MU-MIMO scheme may be applied for the plurality of users/STAs.

The set of user-specific fields includes information on how all users (STAs) of the corresponding PPDU decode their payloads. User-specific fields may contain zero or more user block fields. The non-final user block field includes two user fields (i.e., information to be used for decoding in two STAs). The final user block field contains one or two user fields. The number of user fields may be indicated by the RU allocation subfield of HE-SIG-B, the number of symbols of HE-SIG-B, or the MU-MIMO user field of HE-SIG-A. A User-specific field may be encoded separately from or independently of a common field.

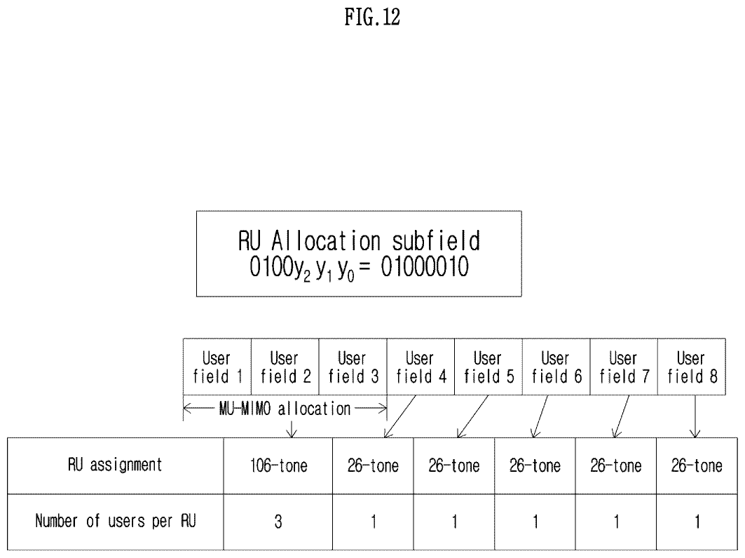

FIG. 12 is a diagram for explaining a MU-MIMO method in which a plurality of users/STAs are allocated to one RU.

In the example of FIG. 12, it is assumed that the value of the RU allocation subfield is 01000010. This corresponds to the case where y2y1y0=010 in 01000y2y1y0. 010 corresponds to 2 in decimal (i.e., N=2) and may indicate that 3 (=N+1) users are allocated to one RU. In this case, one 106-RU and five 26-RUs may be sequentially allocated from the leftmost side to the rightmost side of a specific 20 MHz band/channel. Three users/STAs may be allocated to the 106-RU in a MU-MIMO manner. As a result, a total of 8 users/STAs are allocated to the 20 MHz band/channel, and the user-specific field of HE-SIG-B may include 8 user fields (i.e., 4 user block fields). Eight user fields may be assigned to RUs as shown in FIG. 12.

The user field may be constructed based on two formats. The user field for a MU-MIMO allocation may be constructed with a first format, and the user field for non-MU-MIMO allocation may be constructed with a second format. Referring to the example of FIG. 12, user fields 1 to 3 may be based on the first format, and user fields 4 to 8 may be based on the second format. The first format and the second format may contain bit information of the same length (e.g., 21 bits).

The user field of the first format (i.e., format for MU-MIMO allocation) may be constructed as follows. For example, out of all 21 bits of one user field, B0-B10 includes the user's identification information (e.g., STA-ID, AID, partial AID, etc.), B11-14 includes spatial configuration information such as the number of spatial streams for the corresponding user, B15-B18 includes Modulation and Coding Scheme (MCS) information applied to the Data field of the corresponding PPDU, B19 is defined as a reserved field, and B20 may include information on a coding type (e.g., binary convolutional coding (BCC) or low-density parity check (LDPC)) applied to the Data field of the corresponding PPDU.

The user field of the second format (i.e., the format for non-MU-MIMO allocation) may be constructed as follows. For example, out of all 21 bits of one user field, B0-B10 includes the user's identification information (e.g., STA-ID, AID, partial AID, etc.), B11-13 includes information on the number of spatial streams (NSTS) applied to the corresponding RU, B14 includes information indicating whether beamforming is performed (or whether a beamforming steering matrix is applied), B15-B18 includes Modulation and Coding Scheme (MCS) information applied to the Data field of the corresponding PPDU, B19 includes information indicating whether DCM (dual carrier modulation) is applied, and B20 may include information on a coding type (e.g., BCC or LDPC) applied to the Data field of the corresponding PPDU.

MCS, MCS information, MCS index, MCS field, and the like used in the present disclosure may be indicated by a specific index value. For example, MCS information may be indicated as index 0 to index 11. MCS information includes information on constellation modulation type (e.g., BPSK, QPSK, 16-QAM, 64-QAM, 256-QAM, 1024-QAM, etc.), and coding rate (e.g., 1/2, 2/3, 3/4, 5/6, etc.). Information on a channel coding type (e.g., BCC or LDPC) may be excluded from the MCS information.

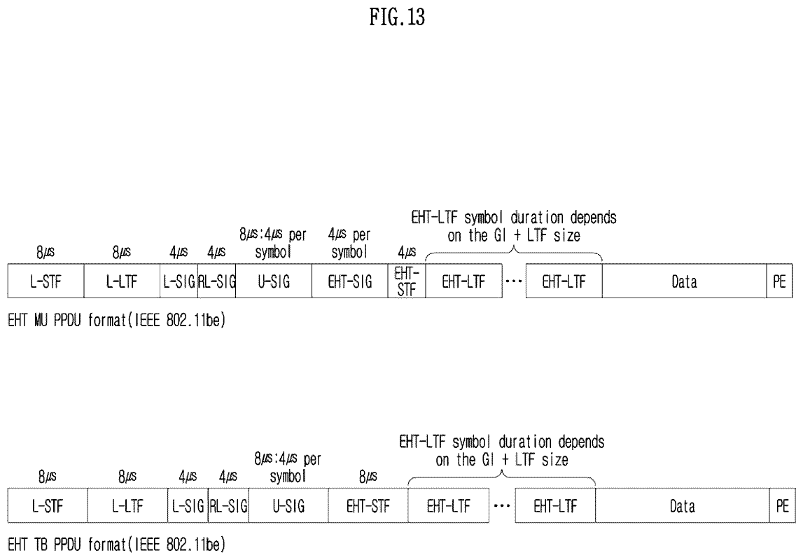

FIG. 13 illustrates an example of a PPDU format to which the present disclosure may be applied.

The PPDU of FIG. 13 may be referred as various names such as an EHT PPDU, a transmitted PPDU, a received PPDU, a first type or an N^{th} type PPDU. For example, the PPDU or EHT PPDU of the present disclosure may be referred as various names such as a transmission PPDU, a reception PPDU, a first type or an N^{th} type PPDU. In addition, the EHT PPU may be used in an EHT system and/or a new wireless LAN system in which the EHT system is improved.

The EHT MU PPDU of FIG. 13 corresponds to a PPDU carrying one or more data (or PSDUs) for one or more users. That is, the EHT MU PPDU may be used for both SU transmission and MU transmission. For example, the EHT MU PPDU may correspond to a PPDU for one receiving STA or a plurality of receiving STAs.

In the EHT TB PPDU of FIG. 13, the EHT-SIG is omitted compared to the EHT MU PPDU. Upon receiving a trigger for UL MU transmission (eg, a trigger frame or TRS), the STA may perform UL transmission based on the EHT TB PPDU format.

In the example of the EHT PPDU format of FIG. 13, L-STF to EHT-LTF correspond to a preamble or a physical preamble, and may be generated/transmitted/received/acquired/decoded in the physical layer.

A Subcarrier frequency spacing of L-STF, L-LTF, L-SIG, RL-SIG, Universal SIGNAL (U-SIG), EHT-SIG field (these are referred to as pre-EHT modulated fields) may be set to 312.5 kHz. A subcarrier frequency spacing of the EHT-STF, EHT-LTF, Data, and PE field (these are referred to as EHT modulated fields) may be set to 78.125 kHz. That is, the tone/subcarrier index of L-STF, L-LTF, L-SIG, RL-SIG, U-SIG, and EHT-SIG field may be indicated in units of 312.5 kHz, and the tone/subcarrier index of EHT-STF, EHT-LTF, Data, and PE field may be indicated in units of 78.125 kHz.

The L-LTF and L-STF of FIG. 13 may be constructed identically to the corresponding fields of the PPDU described in FIGS. 6 to 7.

The L-SIG field of FIG. 13 may be constructed with 24 bits and may be used to communicate rate and length information. For example, the L-SIG field includes a 4-bit Rate field, a 1-bit Reserved bit, a 12-bit Length field, a 1-bit Parity field, and a 6-bit Tail field may be included. For example, the 12-bit Length field may include information on a time duration or a length of the PPDU. For example, a value of the 12-bit Length field may be determined based on the type of PPDU. For example, for a non-HT, HT, VHT, or EHT PPDU, the value of the Length field may be determined as a multiple of 3. For example, for the HE PPDU, the value of the Length field may be determined as a multiple of 3+1 or a multiple of 3+2.

For example, the transmitting STA may apply BCC encoding based on a coding rate of 1/2 to 24-bit information of the L-SIG field. Thereafter, the transmitting STA may obtain 48-bit BCC coded bits. BPSK modulation may be applied to 48-bit coded bits to generate 48 BPSK symbols. The transmitting STA may map 48 BPSK symbols to any location except for a pilot subcarrier (e,g,, {subcarrier index −21, −7, +7, +21}) and a DC subcarrier (e.g., {subcarrier index 0}). As a result, 48 BPSK symbols may be mapped to subcarrier indices −26 to −22, −20 to −8, −6 to −1, +1 to +6, +8 to +20, and +22 to +26. The transmitting STA may additionally map the signals of {−1, −1, −1, 1} to the subcarrier index {−28, −27, +27, +28}. The above signal may be used for channel estimation in the frequency domain corresponding to {−28, −27, +27, +28}.

The transmitting STA may construct RL-SIG which is constructed identically to L-SIG. For RL-SIG, BPSK modulation is applied. The receiving STA may recognize that the received PPDU is a HE PPDU or an EHT PPDU based on the existence of the RL-SIG.

After the RL-SIG of FIG. 13, a Universal SIG (U-SIG) may be inserted. The U-SIG may be referred as various names such as a first SIG field, a first SIG, a first type SIG, a control signal, a control signal field, and a first (type) control signal, etc.

The U-SIG may include N-bit information and may include information for identifying the type of EHT PPDU. For example, U-SIG may be configured based on two symbols (e.g., two consecutive OFDM symbols). Each symbol (e.g., OFDM symbol) for the U-SIG may have a duration of 4 us, and the U-SIG may have a total 8 us duration. Each symbol of the U-SIG may be used to transmit 26 bit information. For example, each symbol of the U-SIG may be transmitted and received based on 52 data tones and 4 pilot tones.

Through the U-SIG (or U-SIG field), for example, A bit information (e.g., 52 un-coded bits) may be transmitted, the first symbol of the U-SIG (e.g., U-SIG-1) may transmit the first X bit information (e.g., 26 un-coded bits) of the total A bit information, and the second symbol of the U-SIG (e.g., U-SIG-2) may transmit the remaining Y-bit information (e.g., 26 un-coded bits) of the total A-bit information. For example, the transmitting STA may obtain 26 un-coded bits included in each U-SIG symbol. The transmitting STA may generate 52-coded bits by performing convolutional encoding (e.g., BCC encoding) based on a rate of R=1/2, and perform interleaving on the 52-coded bits. The transmitting STA may generate 52 BPSK symbols allocated to each U-SIG symbol by performing BPSK modulation on the interleaved 52-coded bits. One U-SIG symbol may be transmitted based on 56 tones (subcarriers) from subcarrier index −28 to subcarrier index +28, except for DC index 0. The 52 BPSK symbols generated by the transmitting STA may be transmitted based on the remaining tones (subcarriers) excluding pilot tones −21, −7, +7, and +21 tones.

For example, the A bit information (e.g., 52 un-coded bits) transmitted by the U-SIG includes a CRC field (e.g., a 4-bit field) and a tail field (e.g., 6 bit-length field). The CRC field and the tail field may be transmitted through the second symbol of the U-SIG. The CRC field may be constructed based on 26 bits allocated to the first symbol of U-SIG and 16 bits remaining except for the CRC/tail field in the second symbol, and may be constructed based on a conventional CRC calculation algorithm. In addition, the tail field may be used to terminate the trellis of the convolution decoder, and for example, the tail field may be set to 0.

A bit information (e.g., 52 un-coded bits) transmitted by the U-SIG (or U-SIG field) may be divided into version-independent bits and version-dependent bits. For example, a size of the version-independent bits may be fixed or variable. For example, the version-independent bits may be allocated only to the first symbol of U-SIG, or the version-independent bits may be allocated to both the first symbol and the second symbol of U-SIG. For example, the version-independent bits and the version-dependent bits may be referred as various names such as a first control bit and a second control bit, etc.

For example, the version-independent bits of the U-SIG may include a 3-bit physical layer version identifier (PHY version identifier). For example, the 3-bit PH-Y version identifier may include information related to the PHY version of the transmitted/received PPDU. For example, the first value of the 3-bit PHY version identifier may indicate that the transmission/reception PPDU is an EHT PPDU. In other words, when transmitting the EHT PPDU, the transmitting STA may set the 3-bit PHY version identifier to a first value. In other words, the receiving STA may determine that the received PPDU is an EHT PPDU based on the PHY version identifier having the first value.

For example, the version-independent bits of U-SIG may include a 1-bit UL/DL flag field. A first value of the 1-bit UL/DL flag field is related to UL communication, and a second value of the UL/DL flag field is related to DL communication.

For example, the version-independent bits of the U-SIG may include information on the length of a transmission opportunity (TXOP) and information on a BSS color ID.

For example, if the EHT PPDU is classified into various types (e.g., EHT PPDU related to SU mode, EHT PPDU related to MU mode, EHT PPDU related to TB mode, EHT PPDU related to Extended Range transmission, etc.), information on the type of EHT PPDU may be included in the version-dependent bits of the U-SIG.

For example, the U-SIG may include information on 1) a bandwidth field containing information on a bandwidth, 2) a field containing information on a MCS scheme applied to EHT-SIG, 3) an indication field containing information related to whether the DCM technique is applied to the EHT-SIG, 4) a field containing information on the number of symbols used for EHT-SIG, 5) a field containing information on whether EHT-SIG is constructed over all bands, 6) a field containing information on the type of EHT-LTF/STF, and 7) a field indicating the length of EHT-LTF and CP length.

Preamble puncturing may be applied to the PPDU of FIG. 13. Preamble puncturing may mean transmission of a PPDU for which no signal is present in one or more 20 MHz subchannels among the bandwidth of the PPDU. Preamble puncturing may be applied to a PPDU transmitted to one or more users. For example, the resolution of preamble puncturing may be 20 MHz for EHT MU PPDUs in OFDMA transmissions with bandwidths greater than 40 MHz and non-OFDMA transmissions with 80 MHz and 160 MHz bandwidths. That is, in the above case, puncturing on a subchannel smaller than 242-tone RU may not be allowed. In addition, for an EHT MU PPDU in non-OFDMA transmission with a bandwidth of 320 MHz, the resolution of preamble puncturing may be 40 MHz. That is, puncturing for a subchannel smaller than 484-tone RU in a 320 MHz bandwidth may not be allowed. In addition, preamble puncturing may not be applied to the primary 20 MHz channel in the EHT MU PPDU.

For example, for an EHT MU PPDU, information on preamble puncturing may be included in the U-SIG and/or the EHT-SIG. For example, the first field of the U-SIG may include information on the contiguous bandwidth of the PPDU, and the second field of the U-SIG may include information on preamble puncturing applied to the PPDU.

For example, the U-SIG and the EHT-SIG may include information on preamble puncturing based on the following method. If the bandwidth of the PPDU exceeds 80 MHz, the U-SIG may be individually constructed in units of 80 MHz. For example, if the bandwidth of the PPDU is 160 MHz, the PPDU may include a first U-SIG for a first 80 MHz band and a second U-SIG for a second 80 MHz band. In this case, the first field of the first U-SIG includes information on the 160 MHz bandwidth, and the second field of the first U-SIG includes information on preamble puncturing applied to the first 80 MHz band (i.e., information on a preamble puncturing pattern). In addition, the first field of the second U-SIG includes information on a 160 MHz bandwidth, and the second field of the second U-SIG includes information on preamble puncturing applied to a second 80 MHz band (i.e., information on a preamble puncturing pattern). The EHT-SIG following the first U-SIG may include information on preamble puncturing applied to the second 80 MHz band (i.e., information on a preamble puncturing pattern), and the EHT-SIG following the second U-SIG may include information on preamble puncturing applied to the first 80 MHz band (i.e., information on a preamble puncturing pattern).

Additionally or alternatively, the U-SIG and the EHT-SIG may include information on preamble puncturing based on the following method. The U-SIG may include information on preamble puncturing for all bands (i.e., information on a preamble puncturing pattern). That is, EHT-SIG does not include information on preamble puncturing, and only U-SIG may include information on preamble puncturing (ie, information on a preamble puncturing pattern).

U-SIG may be constructed in units of 20 MHz. For example, if an 80 MHz PPDU is constructed, the U-SIG may be duplicated. That is, the same 4 U-SIGs may be included in the 80 MHz PPDU. PPDUs exceeding 80 MHz bandwidth may include different U-SIGs.

The EHT-SIG of FIG. 13 may include control information for the receiving STA. EHT-SIG may be transmitted through at least one symbol, and one symbol may have a length of 4 us. Information on the number of symbols used for EHT-SIG may be included in U-SIG.

The EHT-SIG may include technical features of HE-SIG-B described through FIGS. 11 and 12. For example, EHT-SIG, like the example of FIG. 8, may include a common field and a user-specific field. The Common field of the EHT-SIG may be omitted, and the number of user-specific fields may be determined based on the number of users.

As in the example of FIG. 11, the common field of the EHT-SIG and the user-specific field of the EHT-SIG may be coded separately. One user block field included in the user-specific field may contain information for two user fields, but the last user block field included in the user-specific field may contain one or two user fields. That is, one user block field of the EHT-SIG may contain up to two user fields. As in the example of FIG. 12, each user field may be related to MU-MIMO allocation or non-MU-MIMO allocation.

In the same way as in the example of FIG. 11, the common field of the EHT-SIG may include a CRC bit and a Tail bit, The length of the CRC bit may be determined as 4 bits, and the length of the tail bit is determined by 6 bits and may be set to 000000.

As in the example of FIG. 11, the common field of the EHT-SIG may include RU allocation information. RU allocation information may mean information on the location of an RU to which a plurality of users (i.e., a plurality of receiving STAs) are allocated. RU allocation information may be configured in units of 9 bits (or N bits).

A mode in which a common field of EHT-SIG is omitted may be supported. The mode in which the common field of the EHT-SIG is omitted may be referred as a compressed mode. When the compressed mode is used, a plurality of users (i.e., a plurality of receiving STAs) of the EHT PPDU may decode the PPDU (e.g., the data field of the PPDU) based on non-OFDMA. That is, a plurality of users of the EHT PPDU may decode a PPDU (e.g., a data field of the PPDU) received through the same frequency band. When a non-compressed mode is used, multiple users of the EHT PPDU may decode the PPDU (e.g., the data field of the PPDU) based on OFDMA. That is, a plurality of users of the EHT PPDU may receive the PPDU (e.g., the data field of the PPDU) through different frequency bands.

EHT-SIG may be constructed based on various MCS scheme. As described above, information related to the MCS scheme applied to the EHT-SIG may be included in the U-SIG. The EHT-SIG may be constructed based on the DCM scheme. The DCM scheme may reuse the same signal on two subcarriers to provide an effect similar to frequency diversity, reduce interference, and improve coverage. For example, modulation symbols to which the same modulation scheme is applied may be repeatedly mapped on available tones/subcarriers. For example, modulation symbols (e.g., BPSK modulation symbols) to which a specific modulation scheme is applied may be mapped to first contiguous half tones (e.g., 1^{st} to 26^{th} tones) among the N data tones (e.g., 52 data tones) allocated for EHT-SIG, and modulation symbols (e.g., BPSK modulation symbols) to which the same specific modulation scheme is applied may be mapped to the remaining contiguous half tones (e.g., 27^{th} to 52^{nd} tones). That is, a modulation symbol mapped to the 1st tone and a modulation symbol mapped to the 27th tone are the same. As described above, information related to whether the DCM scheme is applied to the EHT-SIG (e.g., a 1-bit field) may be included in the U-SIG. The EHT-STF of FIG. 13 may be used to enhance automatic gain control (AGC) estimation in a MIMO environment or an OFDMA environment. The EHT-LTF of FIG. 13 may be used to estimate a channel in a MIMO environment or an OFDMA environment.

Information on the type of STF and/or LTF (including information on a guard interval (GI) applied to LTF) may be included in the U-SIG field and/or the EHT-SIG field of FIG. 13.

The PPDU (i.e., EHT PPDU) of FIG. 13 may be constructed based on an example of RU allocation of FIGS. 8 to 10.

For example, a EHT PPDU transmitted on a 20 MHz band, that is, a 20 MHz EHT PPDU may be constructed based on the RU of FIG. 8. That is, a RU location of EHT-STF, EHT-LTF, and data field included in the EHT PPDU may be determined as shown in FIG. 8. A EHT PPDU transmitted on a 40 MHz band, that is, a 40 MHz EHT PPDU may be constructed based on the RU of FIG. 9. That is, a RU location of EHT-STF, EHT-LTF, and data field included in the EHT PPDU may be determined as shown in FIG. 9.

The EHT PPDU transmitted on the 80 MHz band, that is, the 80 MHz EHT PPDU may be constructed based on the RU of FIG. 10. That is, a RU location of EHT-STF, EHT-LTF, and data field included in the EHT PPDU may be determined as shown in FIG. 10. The tone-plan for 80 MHz in FIG. 10 may correspond to two repetitions of the tone-plan for 40 MHz in FIG. 9.

The tone-plan for 160/240/320 MHz may be configured in the form of repeating the pattern of FIG. 9 or 10 several times.

The PPDU of FIG. 13 may be identified as an EHT PPDU based on the following method.

The receiving STA may determine the type of the received PPDU as the EHT PPDU based on the following. For example, when 1) the first symbol after the L-LTF signal of the received PPDU is BPSK, 2) RL-SIG in which the L-SIG of the received PPDU is repeated is detected, and 3) the result of applying the modulo 3 calculation to the value of the Length field of the L-SIG of the received PPDU (i.e., the remainder after dividing by 3) is detected as 0, the received PPDU may be determined as a EHT PPDU. When the received PPDU is determined to be an EHT PPDU, the receiving STA may determine the type of the EHT PPDU based on bit information included in symbols subsequent to the RL-SIG of FIG. 13. In other words, the receiving STA may determine the received PPDU as a EHT PPDU, based on 1) the first symbol after the L-LTF signal, which is BSPK, 2) RL-SIG contiguous to the L-SIG field and identical to the L-SIG, and 3) L-SIG including a Length field in which the result of applying modulo 3 is set to 0.

For example, the receiving STA may determine the type of the received PPDU as the HE PPDU based on the following. For example, when 1) the first symbol after the L-LTF signal is BPSK, 2) RL-SIG in which L-SIG is repeated is detected, and 3) the result of applying modulo 3 to the length value of L-SIG is detected as 1 or 2, the received PPDU may be determined as a HE PPDU.

For example, the receiving STA may determine the type of the received PPDU as non-HT, HT, and VHT PPDU based on the following. For example, when 1) the first symbol after the L-LTF signal is BPSK and 2) RL-SIG in which L-SIG is repeated is not detected, the received PPDU may be determined as non-HT, HT, and VHT PPDU.

In addition, when the receiving STA detects an RL-SIG in which the L-SIG is repeated in the received PPDU, it may be determined that the received PPDU is a HE PPDU or an EHT PPDU. In this case, if the rate (6 Mbps) check fails, the received PPDU may be determined as a non-HT, HT, or VHT PPDU. If the rate (6 Mbps) check and parity check pass, when the result of applying modulo 3 to the Length value of L-SIG is detected as 0, the received PPDU may be determined as an EHT PPDU, and when the result of Length mod 3 is not 0, it may be determined as a HE PPDU.

The PPDU of FIG. 13 may be used to transmit and receive various types of frames. For example, the PPDU of FIG. 13 may be used for (simultaneous) transmission and reception of one or more of a control frame, a management frame, or a data frame.

Hereinafter, the U-SIG included in the EHT PPDU will be described in more detail.

For a 40 MHz EHT PPDU or Extended Range (ER) preamble, the U-SIG content is the same in both 20 MHz subchannels. For an 80 MHz EHT PPDU or ER preamble, the U-SIG content is the same in all non-punctured 20 MHz subchannels. For a 160/320 MHz EHT PPDU or ER preamble, the U-SIG content is the same on all non-punctured 20 MHz subchannels within each 80 MHz subblock and may be different from the U-SIG content in other 80 MHz subblocks.

The U-SIG-1 part of the U-SIG of the EHT MU PPDU may include PHY version identifier (B0-B2), BW (B3-B5), UL/DL (B6), BSS color (B7-B12), and TXOP (B13-B19), and U-SIG-2 part may include PPDU type and compression mode (BF-B1), validate (B2), punctured channel information (B3-B7), validate (B8), EHT-SIG MCS (B9-B10), number of EHT-SIG symbols (B11-B15), CRC (B16-B19), and tail (B20-B25).

Here, an example ofa 5-bit punctured channel indication for a non-OFDMA case in the EHT MU PPDU is shown in Table 1 below.

TABLE 1

| PPDU | | | | |
|---|---|---|---|---|
| bandwidth | | Cases | Punturing pattern | Field value |
| 20/40 | MHz | No puncturing | [1 1 1 1] | 0 |
| 80 | MHz | No puncturing | [1 1 1 1] | 0 |
| | | No puncturing | [x 1 1 1] | 1 |
| | | | [1 x 1 1] | 2 |
| | | | [1 1 x 1] | 3 |
| | | | [1 1 1 x] | 4 |
| 160 | MHz | No puncturing | [1 1 1 1 1 1 1 1] | 0 |
| | | 20 MHz puncturing | [x 1 1 1 1 1 1 1] | 1 |
| | | | [1 x 1 1 1 1 1 1] | 2 |
| | | | [1 1 x 1 1 1 1 1] | 3 |
| | | | [1 1 1 x 1 1 1 1] | 4 |
| | | | [1 1 1 1 x 1 1 1] | 5 |
| | | | [1 1 1 1 1 x 1 1] | 6 |
| | | | [1 1 1 1 1 1 x 1] | 7 |
| | | | [1 1 1 1 1 1 1 x] | 8 |
| | | 40 MHz puncturing | [x x 1 1 1 1 1 1] | 9 |
| | | | [1 1 x x 1 1 1 1] | 10 |
| | | | [1 1 1 1 x x 1 1] | 11 |
| | | | [1 1 1 1 1 1 x x] | 12 |
| 320 | MHz | No puncturing | [1 1 1 1 1 1 1 1] | 0 |
| | | 40 MHz puncturing | [x 1 1 1 1 1 1 1] | 1 |
| | | | [1 x 1 1 1 1 1 1] | 2 |
| | | | [1 1 x 1 1 1 1 1] | 3 |
| | | | [1 1 1 x 1 1 1 1] | 4 |
| | | | [1 1 1 1 x 1 1 1] | 5 |
| | | | [1 1 1 1 1 x 1 1] | 6 |
| | | | [1 1 1 1 1 1 x 1] | 7 |
| | | | [1 1 1 1 1 1 1 x] | 8 |
| | | 80 MHz puncturing | [x x 1 1 1 1 1 1] | 9 |
| | | | [1 1 x x 1 1 1 1] | 10 |
| | | | [1 1 1 1 x x 1 1] | 11 |
| | | | [1 1 1 1 1 1 x x] | 12 |
| | | 320-80-40 | [x x x 1 1 1 1 1] | 13 |
| | | | [x x 1 x 1 1 1 1] | 14 |
| | | | [x x 1 1 x 1 1 1] | 15 |
| | | | [x x 1 1 1 x 1 1] | 16 |
| | | | [x x 1 1 1 1 x 1] | 17 |
| | | | [x x 1 1 1 1 1 x] | 18 |
| | | | [x 1 1 1 1 1 x x] | 19 |
| | | | [1 x 1 1 1 1 x x] | 20 |
| | | | [1 1 x 1 1 1 x x] | 21 |
| | | | [1 1 1 x 1 1 x x] | 22 |
| | | | [1 1 1 1 x 1 x x] | 23 |
| | | | [1 1 1 1 1 x x x] | 24 |

In the puncturing pattern of Table 1, 1 denotes a non-punctured subchannel, and x denotes a punctured subchannel. The puncturing granularity for the 80 MHz and 160 MHz PPDU bandwidths may be 20 MHz, and the puncturing granularity for the 320 MHz PPDU bandwidth may be 40 MHz.

Next, the U-SIG-1 part of the U-SIG of the EHT TB PPDU may include a version identifier (B0-B2), BW (B3-B5), UL/DL (B6), BSS color (B7-B12), TXOP (B13-B19), and disregard (B20-B25), and U-SIG-2 part may include PPDU type and compression mode (B0-B1), validate (B2), spatial reuse 1 (B3-B6), spatial reuse 2 (B7-B10), disregard (B11-B15), CRC (B16-B19), and tail (B20-B25).

As described above, the U-SIG field of the EHT MU PPDU includes 5-bit punctured channel information, but the EHT TB PPDU does not include punctured channel information. This is because it is assumed that the EHT TB PPDU is constructed according to resource allocation indicated by the trigger frame or TRS control information, so the STA does not need to inform the AP of the resource information of the EHT TB PPDU.

In addition, even if the trigger frame or TRS control information as described above is received, the STA may not respond with the HE TB PPDU. For example, if, in the non-AP STA, a common information field included in the trigger frame or one or more subfields of an user field addressed to the non-AP STA or selected by the non-AP STA are not recognized, supported, or have an unsatisfied value, the corresponding non-AP STA may choose not to respond to the trigger frame. Similarly, if, in the non-AP STA, a TRS control subfield included in a frame addressed to the non-AP STA is not recognized by the non-AP STA, is not supported, or has an unsatisfied value, the corresponding non-AP STA may choose not to respond to the TRS control subfield.

### Sounding Protocol Sequence

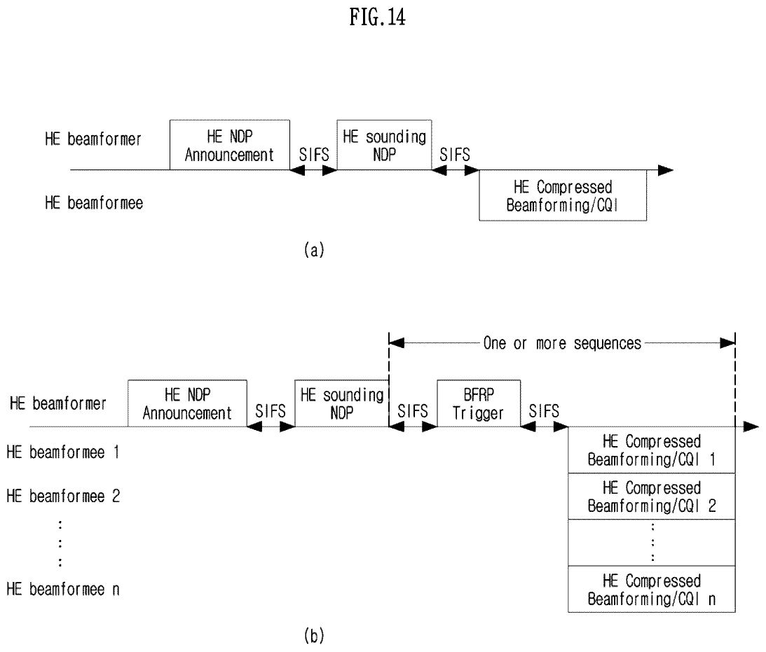

FIG. 14 is a diagram for explaining the HE Non-TB/TB sounding procedure to which the present disclosure may be applied.

As shown in (a) of FIG. 14, HE non-trigger (non-TB) based sounding sequence is initiated by the HE beamformer with an individually addressed HE NDP announcement frame including one STA information field, and after SIFS, the HE sounding NDP may be transmitted to the (single) HE beamformer. The HE beamformer may receive the HE sounding NDP from the HE beamformer and, after SIFS, respond by transmitting a HE compressed beamforming/CQI frame to the HE beamformer.

If the STA identified by the RA (receiver address) field is a mesh STA, AP, or IBSS STA, the AID11 subfield of the STA information field may be set to 0 or the AID of the STA identified by the RA field of the HE NDP announcement frame.

Specifically, the HE beamformer that starts the HE non-TB sounding sequence must transmit a HE NDP announcement frame with a single STA information (Info) field, and if the STA identified by the RA field is a mesh STA, AP, or IBSS member STA, the AID11 field value of the corresponding STA information field may be set to 0 or the AID of the STA identified by the RA field, rather than 2047. The HE beamformer may initiate a HE non-TB sounding sequence with the HE beamformer to request SU feedback across the entire bandwidth. The HE beamformer may not start HE non-TB with a HE NDP announcement frame with a partial BW info subfield indicating less than the full bandwidth.

As shown in (b) of FIG. 14, the HE TB sounding sequence may be performed by transmission of a broadcast HE NDP announcement frame with two or more STA information fields by a HE beamformer, HE sounding NDP after SIFS, and transmission of BFRP trigger frame after SIFS. One or more HE beamformers may receive a BFPR trigger frame and, after SIFS, respond with a HE compressed beamforming/CQI frame. Here, the BFRQ trigger frame may include one or more user information (user info) fields that identify the HE beamformer.

The HE beamformer that starts the HE TB sounding sequence may transmit a HE NDP announcement frame that includes two or more STA information fields and an RA field set as a broadcast address. The HE beamformer may initiate a HE TB sounding sequence to request MU feedback across the entire bandwidth.

The HE beamformer may initiate a HE TB sounding sequence to request a feedback variant only if the feedback variant is calculated based on parameters supported by the HE beamformer. Otherwise, the HE beamformer may not request a feedback variant calculated based on parameters that the HE beamformer does not support.

HE beamformer that transmits the HE NDP announcement frame to the HE beamformer that is an AP TDLS peer STA, mesh STA, or IBSS STA may include one STA information (info) field in the HE NDP announcement frame and set the AID11 field to 0 in the STA information field of the frame.

A HE beamformer that is an AP and transmits a HE NDP announcement frame to one or more HE beamformers may set the AID11 field of the STA information field identifying the non-AP STA to 11 LSB of the AID of the non-AP STA. The HE NDP announcement frame may not include multiple STA information fields with the same value in the AID11 subfield.

HE beamformer transmitting HE NDP announcement frame starting HE TB sounding sequence may include an STA information field with an AID11 subfield value of 2047 to indicate a disallowed subchannel during punctured channel operation. If the STA information field is present, the STA information field with an AID11 value of 2047 may be the first STA information field of the frame. The HE beamformer transmitting the HE NDP announcement frame may not include one or more STA information fields with an AID11 subfield value of 2047.

As shown in (b) of FIG. 14, the HE beamformer that started the HE TB sounding sequence may transmit another BFRP trigger frame on the same TXOP. The HE beamformer may use an additional BFRP trigger frame to request HE compressed beamforming/CQI reporting that was not processed in the previous BFRP trigger frame or to request retransmission of the HE compressed beamforming/CQI report. The HE beamformer may not transmit a BFRP trigger frame identifying the STA identified in the HE NDP Announcement frame of the HE TB sounding sequence unless it is in the same TXOP as the HE TB sounding sequence.

In the HE TB sounding sequence, STA information field in HE NDP announcement frame requesting SU or MU feedback may indicate the subcarrier grouping (Ng), codebook size, and number of columns (Nc) to be used by the HE beamformer identified by the STA information field for generation of SU or MU feedback. And, in the HE TB sounding sequence, the STA information field of the HE NDP announcement frame requesting CQI feedback may indicate the Nc to be used by the HE beamformer identified by the STA information field for generation of CQI feedback.

Additionally, a trigger dependent common info subfield may not exist in the BFRQ trigger frame. The trigger dependent user info subfield of the BFRQ trigger frame may indicate a feedback segment retransmission and the bitmap subfield may indicate a requested feedback segment of the HE compressed beamforming report.

If the bit at position n (n=0 for LSB, n=7 for MSB) in the subfield is 1, a feedback segment with n in the Remaining Feedback Segment subfield of the HE MIMO control field may be requested. If the bit at position n in the subfield is 0, the feedback segment whose remaining feedback segment subfield of the HE MIMO control field is n may be requested.

### Null Data Packet (NDP) Announcement Frame Format

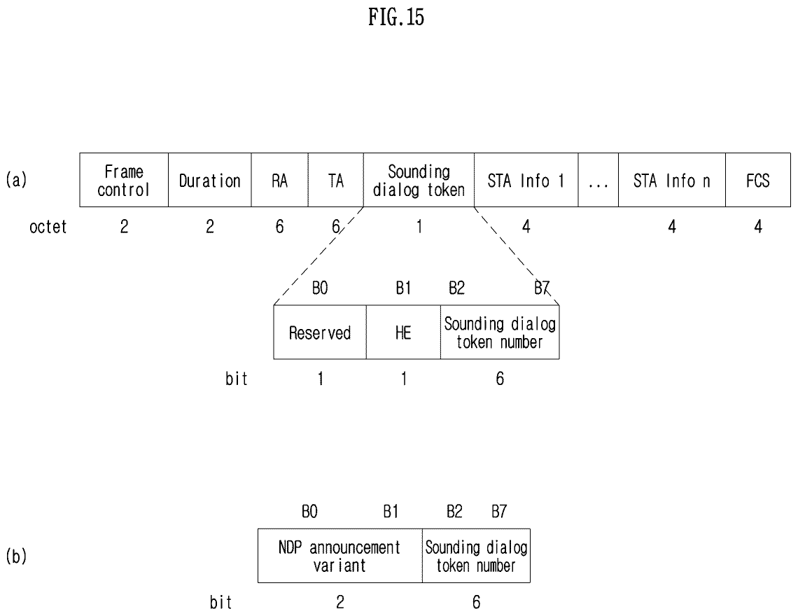

FIG. 15 is a diagram illustrating an NDP announcement frame in a wireless communication system to which the present disclosure may be applied.

(a) of FIG. 15 illustrates the HE NDP announcement frame format. (b) of FIE. 15 illustrates the sounding dialog token field.

The NDP announcement frame may have three variants: VHT NDP announcement frame, HE NDP announcement frame, Ranging NDP announcement frame, and EHT NDP announcement frame. The three formats may be distinguished by the setting of the NDP announcement variant subfield in the sounding dialog token field.

The NDP accouncement frame includes at least one STA information (STA info) field. If the NDP accouncement frame contains only one STA info field, in the case of a VHT or HE NDP accouncement frame, the receiver address (RA) field is set to the address of the STA that may provide feedback, on the other hand, in the case of a Ranging NDP accouncement frame, the RA address is set to the address of a responding STA (RSTA) or an initiating STA (ISTA), which is the intended recipient of the frame. If the NDP accouncement frame includes more than one STA info field, the RA field is set to the broadcast address.

The transmitter address (TA) field is set to the address of the STA transmitting the NDP accouncement frame or the bandwidth signaling TA of the STA transmitting the NDP accouncement frame.

Referring to (a) of FIG. 15, the sounding dialog token field may include reserved bits, an HE subfield, and a sounding dialog token number subfield. The HE subfield may be set to 0 to identify that the frame is a VHT NDP announcement frame, and may be set to 1 to identify that the frame is a HE NDP announcement frame. In a wireless communication system in which the ranging NDP announcement frame is not used, the sounding dialog token field is configured as shown in (a) of FIG. 15, so that the formats of the VHT/HE NDP announcement frame may be distinguished.

Referring to (b) of FIG. 15, in a wireless communication system in which a ranging NDP announcement frame and an EHT NDP announcement frame are also used, the sounding dialog token field may include an NDP announcement variant subfield and a sounding dialog token number subfield.

If the value of the NDP announcement variant subfield is 00, the format of the NDP announcement frame may indicate a VHT NDP announcement frame, if 01, the format of the NDP announcement frame may indicate a Ranging NDP announcement frame, if 10, the format of the NDP announcement frame may indicate the HE NDP announcement frame, and, if 11, the format of the NDP announcement frame may indicate the EHT NDP announcement frame.

### Method of Constructing a Sensing NDPA (Null Data Packet Announcement) Frame

The development of standard technology for sensing movements or gestures of STAs or people using wireless LAN signals operating in the sub-7 GHz band is being considered.

The sensing procedure refers to a procedure for obtaining recognition information on the surrounding environment based on information on the channel environment (or state) included in the signal transmitted from the transmitting end to the receiving end. Each STA may provide additional services that may be applied in various forms in real life based on information on the surrounding environment obtained through sensing procedures.

Here, for example, information on the surrounding environment may include gesture recognition information, fall detection information, intrusion detection information, user motion detection, health monitoring information, or pet movement detection, etc.

The sensing procedure may consist of at least one of a sensing session setup step, a sensing measurement setup step, a sensing measurement instance step, a sensing measurement setup termination step, and a sensing session session termination step.

Here, a sensing session may be defined as one cycle of receiving/measuring a sensing signal after the sensing signal is transmitted and may be composed of one or more sensing measurement instances.

A sensing session may be composed of multiple sub-sessions, and each sub-session may include a measurement step and a reporting step. Here, the sub-session may be expressed as a sensing burst, (sensing) measurement instance, or measurement burst, etc.

An STA that initiates the sensing procedure by transmitting a sensing measurement setup request frame, etc. may be referred to as a sensing initiator, and an STA that participates in a sensing procedure (or sensing session) in response to a sensing initiator may be referred to as a sensing responder.

The role of the STA that initiates or participates in the sensing procedure may be a sensing transmitter or/and a sensing receiver. The sensing transmitter refers to an STA that transmits a PPDU used for measurement in the sensing procedure, and a sensing receiver refers to an STA that receives a PPDU received from a sensing sender in a sensing procedure and obtains a measurement result based on it.

Meanwhile, in order to improve accuracy and resolution of WLAN sensing, WLAN sensing using signal transmission and reception channels between multiple sensing STAs is being considered. The sensing STA includes STA and AP. Therefore, in order to efficiently perform WLAN sensing using signal transmission and reception channels between a sensing initiator and multiple responders, channel estimation for each transmission and reception channel is required. In order to efficiently perform channel measurement for multiple transmission and reception channels used in sensing, channel estimation using null data packet (NDP) transmission may be used for sensing, and information on the corresponding NDP transmission is transmitted in NDPA frames. That is, in order to indicate information on the NDP transmission, a sensing STA that performs sensing measurement transmits the sensing NDPA before transmitting the NDP.

Channel measurement for sensing operation may be performed as follows.

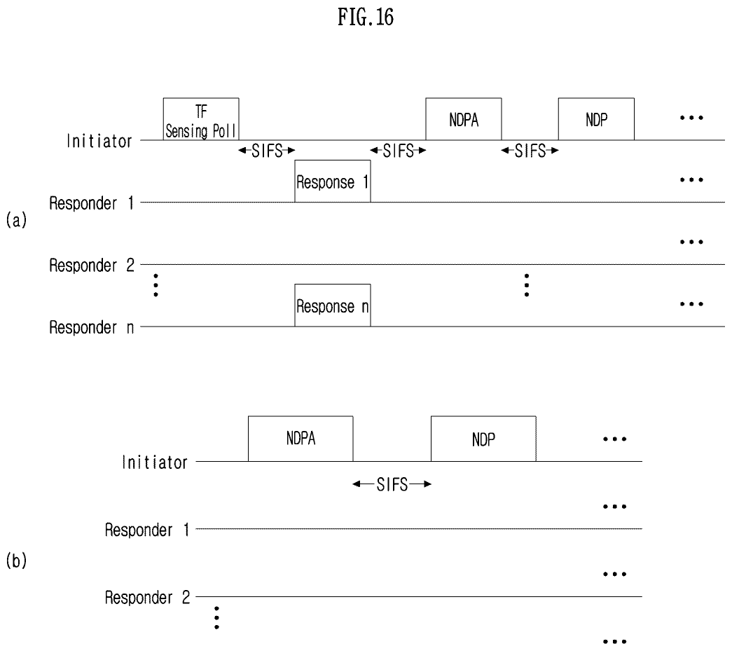

FIG. 16 illustrates a sensing measurement according to an embodiment of the present disclosure.

Sensing measurements are performed in a sensing measurement instance of the WALN measurement procedure. The sensing measurement instance is a time interval in which a sensing measurement is acquired, and may be one of a trigger-based (TB) sensing measurement instance and a non-TB sensing measurement instance.

(a) of FIG. 16 illustrates a TB sensing measurement instance, and (b) of FIG. 16 illustrates a non-TB sensing measurement instance.

Referring to (a) of FIG. 16, TB sensing measurement instance may be applied to a scenario where an AP is a sensing initiator and one or more non-SP STAs are sensing responders. A TB sensing measurement instance includes one or more of the following phases: Polling phase, NDPA sounding phase, Trigger frame (TF) sounding phase, Reporting phase.

During the polling phase, the AP transmits a Sensing Polling Trigger frame to one or more STAs that are assigned to be polled within the TB sensing measurement instance and are expected to participate during the sensing availability window.

The TB sensing measurement instance begins with a polling process when at least one STA is assigned to be polled. Within a TB sensing measurement instance with a polling process, if the AP transmits a Sensing Polling Trigger frame and receives a response from at least one STA, the NDPA sounding and/or TF sounding phase proceeds after SIFS time, and if reporting is required, the reporting phase will occur after SIFS hours following the NDPA sounding and/or TF sounding phase.

In the NDP sounding phase, the AP, which is a sensing transmitter, transmits a Sensing NDP Announcement frame to one or more STAs that are sensing receivers within this NDPA sounding phase, and transmits SI2SR NDP after SIFS. The STA information (STA info) field(s) in the Sensing NDP Announcement frame specifies the STA(s) performing sensing measurements on (based on) the SI2SR NDP transmitted by the AP.

Referring to (b) of FIG. 16, the non-TB sensing measurement instance may be applied to a scenario where the non-AP is the sensing initiator and the AP is the sensing responder. Whenever the medium is available, a non-AP STA may initiate the non-TB sensing measurement instance.

A non-AP STA operating as a sensing initiator initiates the non-TB sensing measurement instance by transmitting a Sensing NDP Announcement frame addressed to the AP which is a sensing responder, and transmits SI2SR NDP after SIFS. The AP may perform sensing measurements on (based on) the received SI2SR NDP. The non-AP STA transmits SI2SR NDP with the same bandwidth as the PPDU carrying the Sensing NDP Announcement frame. The AP that receives the Sensing NDP Announcement frame with the RA field set to basic service set identifier (BSSID) or AP identifier (ID) transmits the SR2SI NDP to the non-AP STA after SIFS after receiving the SI2SR NDP. The AP transmits SR2SI NDP with the same bandwidth as the PPDU carrying the Sensing NDP Announcement frame.

(a) of FIG. 16 and (b) of FIG. 16 are an example for sensing measurement, and in this example, the initiator may be an AP or a non-AP STA.

In order to perform WLAN sensing, as shown in the examples of (a) of FIG. 16 and (b) of FIG. 16, a sensing initiator STA (i.e., sensing initiator) (e.g., AP or non-AP STA) transmits NDP to a sensing responder (e.g., AP or non-AP STA). And, for transmission of NDP, the sensing initiator STA (i.e., sensing initiator) transmits a sensing NDP announcement (NDPA) frame containing information on NDP transmission to the sensing responder.

In this way, in order to indicate that the NDPA frame transmitted including information on NDP is “sensing NDPA”, a method of configuring a sensing NDPA frame using a subtype subfield in the frame control field is proposed in the present disclosure.

In the present disclosure, for convenience of explanation, the field proposed in the present disclosure is referred to as a special STA info field. However, this name is an example and the present disclosure is not limited thereto.

In the present disclosure, sensing responder to sensing initiator (SR2SI) refers to transmission from a sensing responder to a sensing initiator, and may refer to, for example, NDP transmission. Additionally, SR2SI may also be referred to as R2I (responder to initiator).

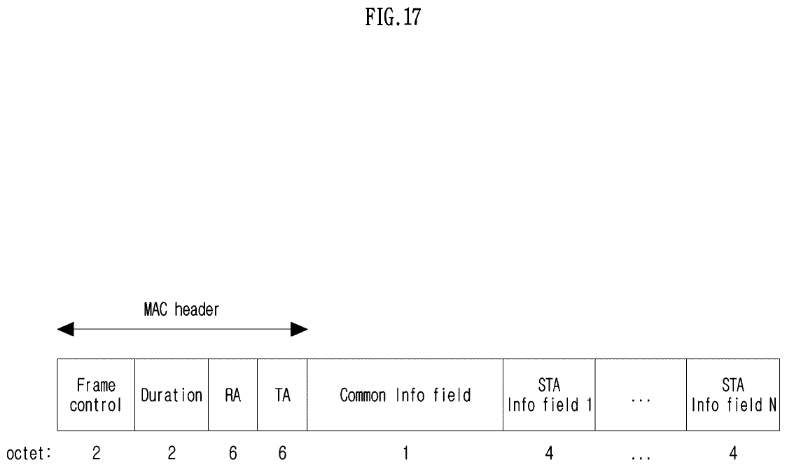

FIG. 17 illustrates a sensing NDPA frame format according to an embodiment of the present disclosure.

Referring to FIG. 17, the sensing NDPA frame may constructed with a frame control field, a duration field, a receiver address (RA) field, a transmitter address (TA) field, a sounding dialog token field, and a common information (common info) field, n (n is a natural number) STA information (STA info) fields.

In the present disclosure, for convenience of explanation, the field proposed in the present disclosure is referred to as a common info field. However, this name is an example and the present disclosure is not limited thereto. In other words, the proposed method of the present disclosure may be applied to any field that carries information commonly applied to sensing STAs.

Referring to FIG. 17, when transmitting Sensing NDPA, the type subfield in the frame control field may be set to 01 (i.e., control frame), and the subtype subfield may be set to 0110 (control frame extension).

The type subfield and subtype subfield in the frame control field together identify the function of the frame. In addition, when the type subfield is 01 and the subtype subfield is 0110, the control frame extension value (4 bits) is used to expand the subtype of the frame.

Here, to indicate the sensing NDPA frame, the Control Frame Extension value (B11 B10 B9 B8) may be set to one of the reserved 1100-1111.

For example, the Control Frame Extension value (B11 B10 B9 B8) may be set to 1100 to indicate a sensing NDPA frame. The Control Frame Extension value setting above is an example, and one of the reserved values may be used.

In this way, since the sensing NDPA frame is defined using the new Control Frame Extension value, there is an advantage in that the sensing NDPA format may be freely configured. For example, fields following the MAC header may be freely configured. In addition, because it uses a new Control Frame Extension value, it has the advantage that ambiguities with the existing NDPA frame do not occur. In other words, the STA that received this may recognize it as a new frame format, so ambiguities issue for the STA info field may not occur.

When sensing NDPA is indicated with the subtype subfield and Control Frame Extension value as above, sensing NDPA may be configured as shown in FIG. 17.

As shown in FIG. 17, in the sensing NDPA frame, the common info field is located after the TA field and may be composed of 2 bytes or 3 bytes. In the present disclosure, for convenience of explanation, the proposed methods are proposed based on the common info field consisting of 2 bytes, but the same may be applied even when the common info field consists of 3 bytes.

Additionally, the size of the STA info field in FIG. 17 is only an example and may be constructed to have a size of 4 bytes or more.

In FIG. 17, the common info field may be constructed to include the following information.

i. PHY Version Identifier or NDPA Variant Identifier

This information (or subfield) may consist of 3 bits and may indicate information about the PHY version or wireless LAN (i.e., wi-fi) protocol for the corresponding NDPA frame.

For example, the information (or subfield) may be used to indicate the version for 802.11bf and next-generation wireless LAN (Wi-Fi) after 802.11bf. For example, among the above 3 bit values, 0 may be used to indicate 802.1 bf, and 1 to 7 may be used to indicate the next version of the wireless LAN (Wi-Fi) protocol after 802.11bf.

ii. PPDU Type or Format Indication: 2 or 3 Bits

For sensing measurement, the sensing STA may perform sensing measurement using the HT/VHT/HE/EHT frame format. Therefore, the information (or subfield) may be used to indicate the frame format or PHY version used for sensing as described above.

The information (or subfield) may be used to indicate the PHY version or PPDU format type used for sensing, and may be constructed as follows, for example, with 2 or 3 bits.

For example, in the case of 2 bits, the information (or subfield) may be constructed as shown in Table 2 below

TABLE 2

| Bits (value) | Contents/Format |
|---|---|
| 00 (0) | HT |
| 01 (1) | VHT |
| 10 (2) | HE |
| 11 (3) | EHT |

As another example, in the case of 3 bits, the information (or subfield) may be constructed as shown in Table 3 below. It may be considered that the sensing NDPA frame of this proposal is used not only in the currently defined PHY version or frame format but also in the next version to be defined later.

TABLE 3

| Bits (value) | Contents)/Format |
|---|---|
| 000 (0) | HT |
| 001 (1) | VHT |
| 010 (2) | HE |
| 011 (3) | EHT |
| 100 (4)~111 (7) | Reserved for Next Wi-fi |

Tables 2 and 3 above are examples, and the indication for the combination and value of each bit may be different.

iii. Sensing Measurement Setup ID Information

Sensing measurement setup ID information (or subfield) may be used to identify the sensing measurement being performed (i.e., to indicate which sensing measurement setup the parameters transmitted in the current frame correspond to), and may be indicated using 2, 3 or 4 bits.

Since it is transmitted through the Special STA info field as above, all sensing STAs that receive their information through sensing NDPA have (assigned) the same sensing measurement setup ID.

iv. Sounding Dialog Token

The sounding dialog token information (or subfield) may be used to identify sounding occurring within a measurement setup.

It may be set the same as the sounding dialog token of the existing NDPA variant and may consists of 6 bits. Additionally, the Sounding dialog token information (or subfield) may be used as a measurement instance identifier (measurement instance ID).

v. Sounding Sequence or Sounding Procedure or Sounding Order

To perform sensing measurements, the sensing STA may perform trigger-based (TB) measurements and non-trigger-based (non-TB) measurements, and various sounding procedures or sounding sequences may be considered for each measurement. Therefore, the information (or subfield) may be used to indicate the sounding procedure or sounding sequence performed for sensing measurement.

Here, the name of the sounding procedure information (or subfield) or sounding sequence information (or subfield) or sounding order information (or subfield) is an example, and the present disclosure is not limited thereto, and may be defined by other information (or subfield) names. For example, it may be referred to/defined as sensing measurement order information (or subfield) or measurement configuration information (or subfield).

The information (or subfield) may be constructed as follows.

For example, the information (or subfield) consists of 3 bits and may be constructed as follows.

### a) Method of Indicating Using all 3 Bits

For example, the information (or subfield) may be defined as a 3-bit table as shown in Table 4 below.

TABLE 4

| Bits (values) | Contents |
|---|---|
| 0 (000) | TB and NDPA sounding (or I2R NDP only) |
| 1 (001) | TB and TF sounding |
| 2 (010) | TB and TF sounding + NDPA sounding |
| 3 (011) | TB and NDPA sounding + TF sound sounding |
| 4 (100) | Non-TB and I2R only use (or not) |
| 5 (101) | Non-TB and R2I only use (or not) |
| 6 (110) | Non-TB and both I2R and R2I use |
| 7 (111) | Reserved |

Table 4 above is an example, and the indication bits and values for each sounding configuration may be set differently.

In Table 4, NDPA sounding means ‘NDPA frame+NDP transmission’ sequence and TF sounding means ‘trigger frame+NDP transmission’ sequence.

Additionally, values 4, 5, and 6 in Table 4 may include an indication of whether I2R or R21 NDP is used for measurement in a given non-TB measurement sequence (NDPA+I2R NDP+R21 NDP). In other words, it may be indicated whether only I2R is used (NDPA+I2R NDP), only R2I is used (NDPA+R2I NDP), or both are used (NDPA+I2R NDP+R2I NDP).

In addition, when the value is set to 0 in Table 4, I2R NDP in TB measurement means NDP transmitted by the AP to the non-AP STA.

Additionally, the values 4 and 5 may indicate the use or non-use of a specific NDP. That is, using the above information, sensing responders may not perform decoding or channel measurement for a specific NDP (I2R NDP or R2I NDP) received during non-TB measurement.

Alternatively, unlike the above example, the measurement configuration transmitted through NDPA may be configured to include only information on the measurement sequence transmitted after NDPA, and in this case, the information (or subfield) may be defined as a 3-bit table as shown in Table 5 below.

TABLE 5

| Bit (value) | Contents |
|---|---|
| 0 (000) | TB and NDPA sounding (or I2R only) |
| 1 (001) | TB and NDPA sounding + TF sounding |
| 2 (010) | Non-TB and I2R only use (or not) |
| 3 (011) | Non-TB and R2I only use (or not) |
| 4 (100) | Non-TB and both I2R and R2I use |
| 5 (101) | Reserved |
| 6 (110) | Reserved |
| 7 (111) | Reserved |

Table 5 above is an example, and the indication bits and values for each sounding configuration may be configured differently.

In other words, as instructed above, the STA that has received the NDPA may recognize information on the next phase/process after receiving the NDPA through the information (or subfield).

b) Alternatively, TB and non-TB may be indicated using 1 bit Most significant bit (MSB) or least significant bit among the above 3 bits of the information (or subfield). And, the sounding configuration of the TB and Non-TB may be indicated using the remaining 2 bits.

TABLE 6

| 1 bit (MSB or | | |
|---|---|---|
| LSB) | 2 bits | Contents |
| 0 | 00 | TB and NDPA sounding (or I2R only) |
| 0 | 01 | TB and TF sounding only |
| 0 | 10 | TB and TF sounding + NDPA sounding |
| 0 | 11 | TB and NDPA sounding + TF sounding |
| 1 | 00 | Non-TB and I2R only use (or not) |
| 1 | 01 | Non-TB and R2I only use (or not) |
| 1 | 10 | Non-TB and both I2R and R2I use |
| 1 | 11 | Reserved |

The definition of contents in Table 6 may be applied in the same way as the definition of content in Table 4 above.

Table 6 above is an example, and the indication bits and values for each sounding configuration may be configured differently.

Alternatively, unlike the above example, the sounding configuration transmitted through the NDPA frame may include only information on the measurement sequence transmitted after NDPA. In this case, the information (or subfield) may be configured as shown in Table 7 below.

TABLE 7

| 1 bit (MSB or | | |
|---|---|---|
| LSB) | 2 bits | Contents |
| 0 | 00 | TB and NDPA sounding |
| 0 | 01 | TB and NDPA + TF sounding |
| 0 | 10 | Reserved |
| 0 | 11 | Reserved |
| 1 | 00 | Non-TB and I2R (only use or not) |
| 1 | 01 | Non-TB and R2I (only use or not) |
| 1 | 10 | Non-TB and both I2R and R2I use |
| 1 | 11 | Reserved |

Table 7 above is an example, and the indication bits and values for each sounding configuration may be configured differently.

In addition, in the case of TB in Tables 6 and 7, the NDP defined by NDPA sounding refers to the NDP transmitted by the AP to the non-AP STA and may be referred to as I2R.

Additionally, in the case of non-TB in Tables 6 and 7 above, the values 0 and 1 may indicate the use or non-use of a specific NDP. That is, using the above information, the sensing responder may not perform decoding or channel measurement for a specific received NDP (I2R or R21) when performing non-TB measurement.

vi. Sounding Sequence Repetition

For accurate channel estimation, channel estimation may be performed by repeating the sounding sequence or procedure when performing sensing measurement. The sounding sequence repetition information (or subfield) may be used to indicate this.

For example, the sounding sequence repetition information (or subfield) may consist of 1 or 2 bits. However, this is only one example and may be constructed with a larger bit size (eg, 3 or 4 bits).

In other words, the accuracy of channel estimation may be increased by repeatedly performing sounding within the measurement.

For example, if the sounding sequence repetition information (or subfield) consists of 1 bit, whether or not it is repeated may be indicated through this. For example, if set to 0, it may mean not repeated, and if set to 1, it may mean repeated once, or vice versa.

For example, when the sounding sequence (or procedure) is only TF, if repetition is indicated by the sounding sequence repetition information (or subfield), the measurement may be performed with TF (first)+TF (second). As another example, measurements for the sounding sequence (or procedure) may be performed with NDPA+TF (first) and NDPA+TF (second).

vii. LTF Repetition

This information (or subfield) may be used to indicate whether the LTF symbol of the NDP used in the sensing measurement is repeated, and may consist of 1 or 2 bits.

a) For example, for 1 bit,
it may indicate whether repetition of the LTF symbol is used in NDP, and if 0, it may indicate no repetition, and if 1, it may indicate repetition. Alternatively, conversely, whether or not to use repetition may be indicated by indicating 1 as no repetition and 0 as repetition.

Here, for example, the repetition of the LTF symbol above may be fixed to 2.

b) For example, for 2 bits,

Table 8 below shows information on repetition of LTF symbols applied during NDP transmission, and as an example, it may be expressed as follows.

TABLE 8

| Value (bits) | Repetition of LTF symbol |
|---|---|
| 00 | No repetition |
| 01 | 2x repetition |
| 10 | 4x repetition |
| 11 | Reserved |

Table 8 above is an example, and may be used in different repetitions from the example in Table 8. Additionally, the reserved may be used 8 times repetition.

As described above, when the Sensing NDPA frame includes a common information field, the STA info field may be configured as follows.

The STA info field included in Sensing NDPA may be composed of 4 bytes the same as the HE/EHT NDPA variant, and may include the following information. However, the size of the STA info field is only an example and may be larger than 4 bytes.
i. AID: it may consists of 11 bits and may indicate information for identification of the STA. This may be considered/interpreted to have the same meaning as STA ID.
ii. partial BW info (PBI): 9 bits

Partial BW info (PBI) information (or subfield) may indicate information on the bandwidth (BW) over which the NDP transmitted following NDPA is transmitted. Using this information, the sensing STA may recognize that NDP is transmitted using non-continuous BW.

Additionally, the PBI information (or subfield) may be configured to include information on a punctured subchannel or puncturing information.

Among the 9 bits, 1 bit (here, the 1 bit may be MSB or LSB) may indicate granularity for a subchannel. For example, 0 may represent 20 MHz and 1 may represent 40 MHz.

Here, the granularity may be used differently depending on BW (e.g., bandwidth over which NDP is transmitted). For example, it may be used in 20 MHz increments for below 160 MHz, and it may be used in 40 MHz increments for (above) 320 MHz.

Of the remaining 8 bits excluding the 1 bit, each 1 bit may indicate whether or not the subchannel is punctured according to the granularity. For example, 0 may indicate not punctured, and 1 may indicate a punctured channel. Also, the opposite is possible.

For example, the remaining bits other than the bits indicating whether or not to puncture the BW on which NDP is transmitted among all bits (e.g., 9 bits in total) of the PBI information (or subfield), i.e., bits which are not included in the BW, may be set to punctured (i.e., for example, set to all 1). For example, when BW is 80, all remaining bits except for the bits indicating 80 MHz allocated above may indicate that they are punctured. For example, assuming that the third 20 MHz of 80 MHz is punctured, the PBI information (or subfield) may be set as follows.

$$- 9 bits ( B 0 \sim B 8 ) = 000101111$$

Information on the BW from which the STA will receive the NDP, that is, information on the BW from which the channel will be measured, may be indicated through the PBI information (or subfield). Through this information, even an STA with an operating BW smaller than the BW through which the NDP is transmitted may measure the channel using the NDP.

For example, when NDP is transmitted using 160 MHz, and the operating BW of the sensing STA is 80 MHz, by using the PBI information (or subfield) to indicate only 80 MHz corresponding to the operating BW of the sensing STA, the sensing STA may perform channel measurement.

iii. Number of I2R Spatial-Time Streams (I2R N_STS): 3 Bits

This represents the number of spatial-time streams allocated to the I2R NDP used during sensing measurement, and may represent, for example, a number from 1 to 8.

The number of I2R spatial-time streams (I2R N_STS) information (or subfield) may be set to the number of actually allocated spatial-time streams (Nsts)−1.

If I2R NDP is not used (if indicated) through the sounding sequence or sounding procedure information (or subfield) transmitted through the Special STA info field, the value of the number of I2R space-time streams (I2R N_STS) information (or subfield) may be set to a value of 0 so that it always has 1 STS.

The total number of LTF symbols constituting the I2R NDP may be determined through the number of I2R spatial-time streams (I2R N_STS) information (or subfield) and repetition information transmitted through the common info field.

iv. Number of R2I Spatial-Time Streams (R2I N_STS): 3 Bits

This represents the number of spatial-time streams allocated to the R21 NDP used during sensing measurement, and may represent, for example, a number from 1 to 8.

The number of R2I spatial-time streams (R2I N_STS) information (or subfield) may be set to the number of actually allocated spatial-time streams (Nsts)−1.

If R2I NDP is not used (if indicated) through the sounding sequence or sounding procedure information (or subfield) transmitted through the Special STA info field, the value of the number of R2I space-time streams (R2I N_STS) information (or subfield) may be set to a value of 0 so that it always has 1 STS.

The total number of LTF symbols constituting the R21 NDP may be determined through the number of R21 spatial-time streams (R21 N_STS) information (or subfield) and repetition information transmitted through the common info field.

v. Feedback Type: It May Consist of 2 or 3 Bits.

This may be used to indicate information on the feedback type for performing sensing measurement and reporting measured channel information.

For example, if the feedback type information (or subfield) consists of 2 bits, it may be constructed as follows.
00: channel state information (CSI), 01: Threshold, 10: truncated channel impulse response (TCIR), 11: reserved

In addition, in order to consider/use more diverse feedback types in addition to the feedback types considered/exemplified above, the feedback type information (or subfield) may consists of 3 bits.

vi. Ng: 1/2

This represents information on feedback tone grouping used to reduce feedback overhead.

For example, Ng information (or subfield) may be configured with 1 bit. In this case, 0 may indicate 1 tone unit, and 1 may indicate 4 tone units.

As another example, Ng information (or subfield) may be configured with 2 bits. In this case, 00 may indicate 1 tone unit, 01 may indicate 2 tone units, 10 may indicate 4 tone units, and 11 may indicate 8 tone units.

The tone unit is an example and the present disclosure is not limited thereto. In addition, 1/2/4/8/16 tone units may be considered.

As described above, by newly defining the frame using the Control Frame Extension value to indicate the sensing NDPA frame, since not only legacy devices but also 11ax/11be devices may clearly check/identify the frame, there is no need to set up an additional signal field for AID disambiguation, which has the advantage of reducing signaling overhead.

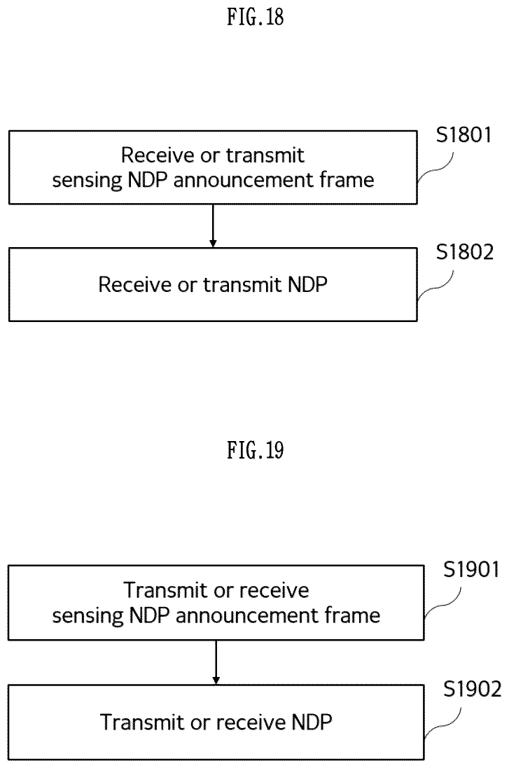

FIG. 18 is a diagram illustrating the operation of an STA for a method for sensing measurement according to an embodiment of the present disclosure.

FIG. 18 illustrates the operation of an STA based on one or a combination of one or more (detailed) methods among the previously proposed methods. The example in FIG. 18 is for convenience of explanation and does not limit the scope of the present disclosure. Some step(s) illustrated in FIG. 18 may be omitted depending on the situation and/or setting. Additionally, the STA in FIG. 18 is only an example and may be implemented with the device previously illustrated in FIG. 1. For example, the processors 102/202 in FIG. 1 may control transmission and reception of frames/signals/data/information, etc. using the transceivers 106/206, and may control to store frames/signals/data/information to be transmitted or received in the memory 104/204.

Referring to FIG. 18, the STA may receive a sensing NDPA frame from the AP (or another STA) (S1801). That is, when the STA is a sensing responder, the STA may receive a sensing NDPA frame from the AP (or another STA).

Alternatively, the STA may transmit a sensing NDPA frame to the AP (or another STA) (S1801). That is, when the STA is the sensing initiator, the STA may transmit a sensing NDPA frame to the AP (or another STA).

Here, the sensing NDPA frame may be constructed according to the method proposed in the present disclosure described above.

For example, the sensing NDPA frame may include a frame control field and a first field (e.g., common information field) including common information related to sensing measurements for a plurality of STAs, and the frame control field may include a subtype subfield. Additionally, to identify the sensing NDPA frame, the value of the subtype subfield may be set to 0110, and the control frame extension value within the subtype subfield may be set to a predetermined value.

Here, the first field may include a format indication subfield for indicating the physical protocol data unit (PPDU) format or physical layer (PHY: physical) version used for sensing measurement. Additionally, the first field may include a sensing measurement setup ID subfield indicating an identifier for sensing measurement. In addition, the first field includes a sounding sequence subfield for indicating the sounding procedure used for sensing measurement, and a different sounding sequence is indicated for each bit value of the sounding sequence subfield, or trigger-based or non-trigger-based measurement is distinguished by 1 bit of the sounding sequence subfield and the remaining bits Different sounding sequences may be indicated for each value. Additionally, the first field may include a sounding sequence repetition subfield indicating whether the sounding sequence used for sensing measurement is repeated. Additionally, the first information field may include an LTF repetition (LTR repetition) subfield indicating whether the long training field (LTF) symbol of the NDP used for sensing measurement is repeated or the number of repetitions.

Additionally, the NDAP frame may include one or more STA info fields containing specific information related to sensing measurements for each STA. Here, the one or more STA information fields may include respectively a partial bandwidth information (PBI: partial bandwidth info) subfield for indicating the bandwidth over which the NDP is transmitted, and the PBI subfield may indicate that the NDP within the bandwidth is transmitted in a discontinuous subchannel. Additionally, 1 bit of the PBI subfield may indicate the granularity of the subchannel, and the remaining bits may indicate whether puncturing is performed for each subchannel.

In addition, the one or more STA info fields may each include a subfield indicating the number of spatial time streams allocated to a specific NDP used for sensing measurement (e.g., I2R NDP transmitted from the sensing initiator to the sensing responder or R2I NDP transmitted from the sensing responder to the sensing initiator). Here, if the specific NDP is not used for sensing measurement, the value of the subfield indicating the number of spatial time streams allocated to the specific NDP may be set to 0 to indicate 1 spatial time stream.

The STA may transmit an NDP to the AP (or another STA) (S1802). That is, when the STA is the sensing initiator, the STA may transmit an NDP to the AP (or another STA).

Alternatively, the STA may receive an NDP from the AP (or another STA) (S1802). That is, when the STA is a sensing responder, the STA may receive an NDP from the AP (or another STA).

The channel may be estimated using (based on) the received NDP. Additionally, when required (or necessary), the STA (or AP) that performed channel estimation may report the channel estimation results. In this way, channel estimation using NDP transmission may be used for sensing.

FIG. 19 is a diagram illustrating the operation of an AP for a method for sensing measurement according to an embodiment of the present disclosure.

FIG. 19 illustrates the operation of an AP based on one or a combination of one or more (detailed) methods among the previously proposed methods. The example in FIG. 19 is for convenience of explanation and does not limit the scope of the present disclosure. Some step(s) illustrated in FIG. 19 may be omitted depending on the situation and/or setting. Additionally, the AP in FIG. 19 is only an example and may be implemented with the device previously illustrated in FIG. 1. For example, the processors 102/202 in FIG. 1 may control transmission and reception of frames/signals/data/information, etc. using the transceivers 106/206, and may control to store frames/signals/data/information to be transmitted or received in the memory 104/204.

Referring to FIG. 19, the AP may transmit a sensing NDPA frame to the STA (S1901). That is, when the AP is the sensing initiator, the AP may transmit a sensing NDPA frame to the STA.

Alternatively, the AP may receive a sensing NDPA frame from the STA (S1901). That is, when the AP is a sensing responder, the AP may receive a sensing NDPA frame from the STA.

Here, the sensing NDPA frame may be constructed according to the method proposed in the present disclosure described above.

For example, the sensing NDPA frame may include a frame control field and a first field (e.g., common information field) including common information related to sensing measurements for a plurality of STAs, and the frame control field may include a subtype subfield. Additionally, to identify the sensing NDPA frame, the value of the subtype subfield may be set to 0110, and the control frame extension value within the subtype subfield may be set to a predetermined value.

Here, the first field may include a format indication subfield for indicating the physical protocol data unit (PPDU) format or physical layer (PHY: physical) version used for sensing measurement. Additionally, the first field may include a sensing measurement setup ID subfield indicating an identifier for sensing measurement. In addition, the first field includes a sounding sequence subfield for indicating the sounding procedure used for sensing measurement, and a different sounding sequence is indicated for each bit value of the sounding sequence subfield, or trigger-based or non-trigger-based measurement is distinguished by 1 bit of the sounding sequence subfield and the remaining bits Different sounding sequences may be indicated for each value. Additionally, the first field may include a sounding sequence repetition subfield indicating whether the sounding sequence used for sensing measurement is repeated. Additionally, the first information field may include an LTF repetition (LTR repetition) subfield indicating whether the long training field (LTF) symbol of the NDP used for sensing measurement is repeated or the number of repetitions.

Additionally, the NDAP frame may include one or more STA info fields containing specific information related to sensing measurements for each STA. Here, the one or more STA information fields may include respectively a partial bandwidth information (PBI: partial bandwidth info) subfield for indicating the bandwidth over which the NDP is transmitted, and the PBI subfield may indicate that the NDP within the bandwidth is transmitted in a discontinuous subchannel. Additionally, 1 bit of the PBI subfield may indicate the granularity of the subchannel, and the remaining bits may indicate whether puncturing is performed for each subchannel.

In addition, the one or more STA info fields may each include a subfield indicating the number of spatial time streams allocated to a specific NDP used for sensing measurement (e.g., I2R NDP transmitted from the sensing initiator to the sensing responder or R21 NDP transmitted from the sensing responder to the sensing initiator). Here, if the specific NDP is not used for sensing measurement, the value of the subfield indicating the number of spatial time streams allocated to the specific NDP may be set to 0 to indicate 1 spatial time stream.

The STA may transmit an NDP to the AP (or another STA) (S1902). That is, when the STA is the sensing initiator, the STA may transmit an NDP to the AP (or another STA).

Alternatively, the STA may receive an NDP from the AP (or another STA) (S1902). That is, when the STA is a sensing responder, the STA may receive an NDP from the AP (or another STA).

The channel may be estimated using (based on) the received NDP. Additionally, when required (or necessary), the STA (or AP) that performed channel estimation may report the channel estimation results. In this way, channel estimation using NDP transmission may be used for sensing.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

A method proposed by the present disclosure is mainly described based on an example applied to an IEEE 802.11-based system, 5G system, but may be applied to various WLAN or wireless communication systems other than the IEEE 802.11-based system.

1. A method performed by a station (STA) in a wireless local area network (WLAN) system, the method performed by a station (STA) comprising:
receiving a sensing null data packet announcement (NDPA) frame from an access point (AP); and
receiving an NDP from the AP;
wherein the sensing NDPA frame includes a frame control field and a first field including common information related to sensing measurements for a plurality of STAs, and the frame control field includes a subtype subfield, and
wherein the value of the subtype subfield is set to 0110, and the control frame extension value in the subtype subfield is set to a pre-determined value, to identify the sensing NDPA frame.

2. The method of claim 1,
wherein the first field includes a format indication subfield for indicating a physical protocol data unit (PPDU) format or physical layer (PHY) version used for sensing measurement.

3. The method of claim 1,
wherein the first field includes a sensing measurement setup ID subfield indicating an identifier for sensing measurement.

4. The method of claim 1,
wherein the first field includes a sounding sequence subfield for indicating a sounding procedure used for sensing measurement, and
wherein a different sounding sequence is indicated for each bit value of the sounding sequence subfield, or
wherein trigger-based or non-trigger-based measurement is distinguished by 1 bit of the sounding sequence subfield, and a different sounding sequence is indicated for each remaining bit value.

5. The method of claim 1,
wherein the first field includes a sounding sequence repetition subfield indicating whether a sounding sequence used for sensing measurement is repeated.

6. The method of claim 1,
wherein the first field includes an LTF repetition subfield indicating whether a long training field (LTF) symbol of the NDP used for sensing measurement is repeated or the number of repetitions.

7. The method of claim 1,
wherein the sensing NDAP frame includes one or more STA info fields including specific information related to sensing measurements for each STA.

8. The method of claim 1,
wherein the one or more STA info fields each include a partial bandwidth info (PBI) subfield for indicating a bandwidth through which the NDP is transmitted, and
wherein the PBI subfield indicates that the NDP within the bandwidth is transmitted in a non-continuous subchannel.

9. The method of claim 8,
wherein 1 bit of the PBI subfield indicates granularity of the subchannel, and remaining bits indicate whether puncturing is performed for each subchannel.

10. The method of claim 7,
wherein the one or more STA info fields each include a subfield indicating a number of spatial time streams allocated to a specific NDP used for sensing measurement.

11. The method of claim 10,
wherein, if the specific NDP is not used for sensing measurement, a value of a subfield indicating the number of spatial time streams allocated to the specific NDP is set to 0 to indicate 1 spatial time stream.

12. A station (STA) used in a wireless LAN system, the STA comprising:
at least one transceiver; and
at least one processor coupled with the at least one transceiver,
wherein the at least one processor is configured to:
receive a sensing null data packet announcement (NDPA) frame from an access point (AP); and
receive an NDP from the AP;
wherein the sensing NDPA frame includes a frame control field and a first field including common information related to sensing measurements for a plurality of STAs, and the frame control field includes a subtype subfield, and
wherein the value of the subtype subfield is set to 0110, and the control frame extension value in the subtype subfield is set to a pre-determined value, to identify the sensing NDPA frame.

13-15. (canceled)

16. An access point (AP) used in a wireless LAN system, the AP comprising:
at least one transceiver; and
at least one processor coupled with the at least one transceiver,
wherein the at least one processor is configured to:
transmit a sensing null data packet announcement (NDPA) frame to a station (STA); and
transmit an NDP to the STA;
wherein the sensing NDPA frame includes a frame control field and a first field including common information related to sensing measurements for a plurality of STAs, and the frame control field includes a subtype subfield, and
wherein the value of the subtype subfield is set to 0110, and the control frame extension value in the subtype subfield is set to a pre-determined value, to identify the sensing NDPA frame.
